(19) United States
(12) Patent Application Publication
(10) Pub. No.: US 2026/0098136 A1
(43) Pub. Date: Apr. 9, 2026

(54) LAMINATE, TOUCH PANEL MEMBER, AND DISPLAY DEVICE

(71) Applicant: DAI NIPPON PRINTING CO., LTD., Tokyo (JP)

(72) Inventors: Kazuki YABUMOTO, Tokyo (JP); Norihiko WANITA, Tokyo (JP); Kazuya HONDA, Tokyo (JP); Kenichi ONODERA, Tokyo (JP); Kohei SHIGEYOSHI, Tokyo (JP); Asaka OKANO, Tokyo (JP)

(21) Appl. No.: 19/112,929

(22) PCT Filed: Sep. 19, 2023
(86) PCT No.: PCT/JP2023/033900

§ 371 Date: Aug. 21, 2025

(30) Foreign Application Priority Data
Sep. 20, 2022 (JP) 2022-148915

(51) Int. Cl. C08J 7/04; C08J 7/046; G06F 3/041

(52) U.S. Cl. CPC C08J 7/042; C08J 7/046; G06F 3/041; C08J 2377/06; G06F 2203/04102

(57) ABSTRACT

The present disclosure provides a layered body including an optical resin layer, a first intermediate layer, a second intermediate layer, and a resin substrate in this order, wherein each of the first intermediate layer and the second intermediate layer contains a first component configuring the resin substrate.

### TECHNICAL FIELD

The present disclosure relates to a layered body and a touch panel member and a display device using the same.

### BACKGROUND ART

A layered body including an optical resin layer having various performances such as hard coat properties, scratch resistance, anti-reflection properties, anti-glare properties, antistatic properties, antifouling properties, and the like is disposed on a surface of a display device, a touch panel, and the like.

Recently, a flexible display such as a foldable display, a rollable display, a bendable display, and the like is noticed, and development of a layered body disposed on the surface of the flexible display has actively been progressed.

The layered body includes a substrate and an optical resin layer disposed on one surface of the substrate. In recent years, from the viewpoint of workability, weight, thickness, flexibility, and the like, the substrate is changed from the glass substrate to the resin substrate.

On the other hand, the resin substrate has a problem that deterioration occurs due to ultraviolet rays. Due to the ultraviolet deterioration of the resin substrate, the close adhesion between the resin substrate and the optical resin layer decreases.

As a technique for suppressing ultraviolet degradation of a resin substrate, a method using an ultraviolet absorber is perceived. For example, Patent Document 1 discloses a layered body including a polyimide film and a hard coat layer in order to improve weather resistance, wherein the hard coat layer contains an ultraviolet absorber. In addition, for example, Patent Document 2 discloses that a polyimide film contains an ultraviolet absorber in order to improve ultraviolet durability. In addition, for example, Patent Document 3 discloses a layered body including a polyimide film and a functional layer for improving weather resistance, wherein an ultraviolet absorber is unevenly distributed on the functional layer side surface of the polyimide film.

### CITATION LIST

### Patent Documents

Patent Document 1: Japanese Patent Application Laid-Open (JP-A) No. 2020-203479
Patent Document 2: Japanese Patent (JP-B) No. 6358358
Patent Document 3: JP-A No. 2019-73013

### SUMMARY

### Technical Problem

However, when the hard coat layer contains an ultraviolet absorber, curing inhibition occurs by the ultraviolet absorber, and characteristics of the hard coat layer, in particular, hardness characteristics may be impaired.

In addition, when the ultraviolet absorber is unevenly distributed on the functional layer side surface of the polyimide film, it is preferable to reduce the thickness of the region containing the ultraviolet absorber in the polyimide film from the point of bending resistance. On the other hand, it is necessary to contain an ultraviolet absorber to some extent in order to obtain a desired weather resistance, but since the content of the ultraviolet absorber is relatively increased as the thickness of the region containing the ultraviolet absorber becomes thinner, the bending resistance may decrease.

The present disclosure has been made in view of the above circumstances, and a main object thereof is to provide a layered body in which deterioration of close adhesion between a resin substrate and an optical resin layer due to ultraviolet degradation of the resin substrate can be suppressed without using an ultraviolet absorber.

### Solution to Problem

An embodiment of the present disclosure provides a layered body including an optical resin layer, a first intermediate layer, a second intermediate layer, and a resin substrate in this order, wherein each of the first intermediate layer and the second intermediate layer each contain a first component configuring the resin substrate.

Another embodiment of the present disclosure provides a layered body including an optical resin layer, an intermediate layer, and a resin substrate in this order, wherein the intermediate layer contains a first component configuring the resin substrate and a second component configuring the optical resin layer.

Another embodiment of the present disclosure provides a layered body including an optical resin layer, an intermediate layer, and a resin substrate in this order, wherein the intermediate layer contains a first component configuring the resin substrate, and when the layered body is subjected to an accelerated weathering test according to JIS K 5600-7-8: 1999 described below, and then an adhesive test is performed by a cross-cut tape method according to JIS K 5400-8.5.2, the number of remaining squares among the 100 squares is 90 or more.

### (Condition of Accelerated Weathering Test)

Operation: Method A, Exposure including steam condensation
UV lamp: Type 2 UVA (340)
Irradiation: Radiated illuminance of 0.63 W/m², temperature of 23±5° C., black panel temperature of 60±3° C., and irradiation time of 4 hours
Steam Condensation: Black panel temperature of 50±3° C., and water condensation time of 4 hours
One cycle: The irradiation and the water vapor condensation are sequentially performed to be one cycle.
Cycle number: 12 cycles

Another embodiment of the present disclosure provides a touch panel member including the above described layered body on a surface.

Another embodiment of the present disclosure provides a display device including a display panel and the above-described layered body disposed on an observer side of the display panel.

### Advantageous Effects

In the present disclosure, it is possible to suppress a decrease in close adhesion between the resin substrate and the optical resin layer due to ultraviolet degradation of the resin substrate without using an ultraviolet absorber.

### BRIEF DESCRIPTION OF DRAWINGS

FIG. 1 is a schematic cross-sectional view illustrating a layered body according to the present disclosure.

FIG. 2 is a schematic cross-sectional view illustrating a layered body according to the present disclosure.

FIG. 3 is a schematic diagram explaining a dynamic bending test.

FIG. 4 is a schematic cross-sectional view illustrating a layered body according to the present disclosure.

FIG. 5 is a schematic cross-sectional view illustrating a display device according to the present disclosure.

### DESCRIPTION OF EMBODIMENTS

Embodiments in the present disclosure are hereinafter explained with reference to, for example, drawings. However, the present disclosure is enforceable in a variety of different forms, and thus should not be taken as is limited to the contents described in the embodiments exemplified as below. Also, the drawings may show the features of the present disclosure such as width, thickness, and shape of each part schematically comparing to the actual form in order to explain the present disclosure more clearly in some cases; however, it is merely an example, and thus does not limit the interpretation of the present disclosure. Also, in the present description and each drawing, for the factor same as that described in the figure already explained, the same reference sign is indicated and the explanation thereof may be omitted.

In the present description, upon expressing an aspect of arranging one member on the other member, when it is expressed simply “on” or “below”, both of when the other member is directly arranged on or below the one member so as to contact with each other, and when the other member is arranged on or below the one member further interposing an additional member, can be included unless otherwise described. Furthermore, in the present description, upon expressing an aspect of arranging the other member in a surface of one member, when expressed simply “in a surface”, both of when the other member is directly arranged on or below the one member so as to contact with each other, and when the other member is arranged on or below the one member further interposing an additional member, can be included unless otherwise described.

Hereinafter, a layered body, a touch panel member, and a display device according to the present disclosure will be described in detail.

### A. Layered Body

A layered body according to the present disclosure has three embodiments. Hereinafter, the embodiments will be described separately.

### I. FIRST EMBODIMENT

A first embodiment of the layered body according to the present disclosure has an optical resin layer, a first intermediate layer, a second intermediate layer, and a resin substrate in this order, and each of the first intermediate layer and the second intermediate layer contains a first component configuring the resin substrate.

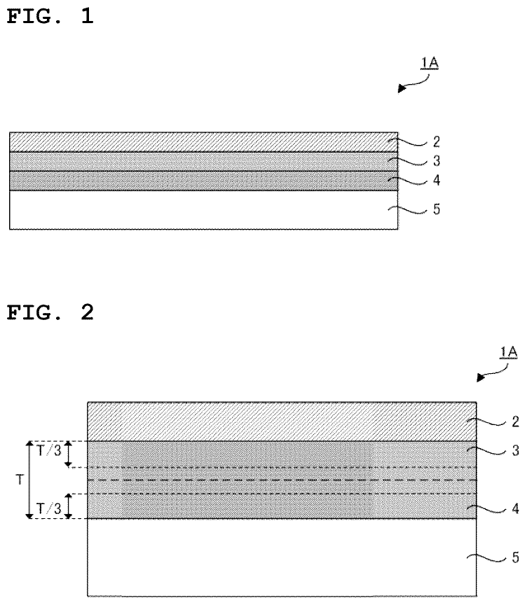

FIG. 1 is a schematic cross-sectional view showing an example of a layered body according to the present embodiment. As shown in FIG. 1, the layered body 1A includes an optical resin layer 2, a first intermediate layer 3, a second intermediate layer 4, and a resin substrate 5 in this order. Each of the first intermediate layer 3 and the second intermediate layer 4 contains a first component configuring the resin substrate 5.

In the present embodiment, the close adhesion between the optical resin layer and the resin substrate can be improved by arranging the first intermediate layer and the second intermediate layer containing the first component configuring the resin substrate between the optical resin layer and the resin substrate.

Here, when the layered body is irradiated with ultraviolet rays from the optical resin layer side surface of the layered body, in the resin substrate, deterioration proceeds from the optical resin layer side surface of the resin substrate. In the present embodiment, since the first intermediate layer and the second intermediate layer disposed between the optical resin layer and the resin substrate contain a first component configuring the resin substrate, even if the first component included in the first intermediate layer and the second intermediate layer deteriorates due to ultraviolet rays, it is possible to suppress deterioration of the resin substrate due to ultraviolet rays. That is, since the first intermediate layer and the second intermediate layer can absorb ultraviolet rays, the ultraviolet degradation of the resin substrate can be suppressed. Therefore, ultraviolet deterioration of the resin substrate can be suppressed, and close adhesion between the optical resin layer and the resin substrate can be maintained.

As described above, in the present embodiment, it is possible to suppress a decrease in close adhesion between the optical resin layer and the resin substrate due to ultraviolet degradation of the resin substrate without using an ultraviolet absorber. Thus, since the optical resin layer contains an ultraviolet absorber as in conventional, it is possible to suppress a decrease in the hardness characteristics of the optical resin layer. In addition, as in conventional, it is possible to prevent the bending resistance from decreasing by unevenly distributing the ultraviolet absorber to the optical resin layer side surface of the resin substrate.

Hereinafter, each configuration of the layered body of the present embodiment will be described.

### 1. Resin Substrate

The resin substrate according to the present embodiment is a member that supports an optical resin layer described later.

### (1) Material of Resin Substrate

The resin configuring the resin substrate is not particularly limited as long as it is a resin capable of obtaining a transparent resin substrate. Above all, the resin substrate preferably contains a resin including at least one selected from the group consisting of an imide skeleton, an amide skeleton, and an ester skeleton. These resins tend to cause ultraviolet deterioration. Therefore, a decrease in close adhesion due to ultraviolet deterioration can be suppressed by applying the present disclosure. In particular, the resin substrate preferably contains a resin including at least an imide skeleton. Since the resin including the imide skeleton easily absorbs ultraviolet rays, ultraviolet degradation tends to occur. Therefore, it is possible to effectively suppress a decrease in close adhesion due to ultraviolet deterioration by applying the present disclosure.

Examples of the resin include polyimide-based resin, polyamide-based resin, polyester-based resin, acrylic resin, and triacetyl cellulose. Examples of the polyimide-based resin include polyimide, polyamideimide, polyetherimide, and polyesterimide. Examples of the polyester-based resin include polyethylene terephthalate, polypropylene terephthalate, polybutylene terephthalate, and polyethylene naphthalate. Among them, a polyimide-based resin and a polyethylene naphthalate are preferable. In particular, from the viewpoint of flexibility and bending resistance, polyimide, polyamideimide, and polyethylene naphthalate are preferable.

Hereinafter, polyimide and polyamideimide will be described as examples.

### (a) Polyimide

The polyimide is obtained by reacting a tetracarboxylic acid component and a diamine component. The polyimide is not particularly limited as long as it has transparency and rigidity. The polyimide preferably includes at least one structure selected from the group consisting of structures represented by the below general formula (1) and the below general formula (3), for example, from points having excellent transparency and excellent rigidity.

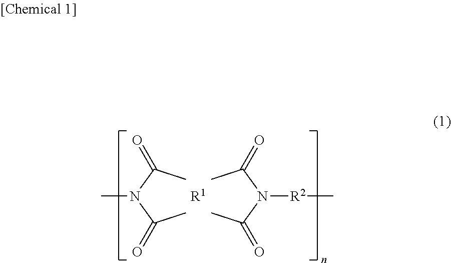

In the general formula (1), R¹ represents a tetravalent group which is a tetracarboxylic acid residue, R² represents at least one divalent group selected from the group consisting of trans-cyclohexanediamine residues, trans-1,4-bismethylene cyclohexanediamine residues, 4,4′-diaminodiphenyl sulfone residues, 3,4′-diaminodiphenyl sulfone residues, and divalent groups represented by the below general formula (2). The n represents the number of repeating units and is 1 or more.

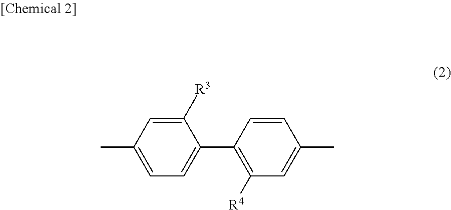

In the general formula (2), R³ and R⁴ each independently represent a hydrogen atom, an alkyl group, or a perfluoroalkyl group.

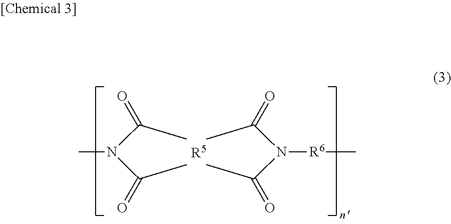

In the general formula (3), R⁵ represents at least one tetravalent group selected from the group consisting of cyclohexanetetracarboxylic acid residues, cyclopentanetetracarboxylic acid residues, dicyclohexane-3,4,3′,4′-tetracarboxylic acid residues, and 4,4′-(hexafluoroisopropylidene)diphthalic acid residues, and R⁶ represents a divalent group that is a diamine residue. The n′ represents the number of repeating units and it is 1 or more.

The “tetracarboxylic acid residue” represents a residue obtained by removing four carboxyl groups from the tetracarboxylic acid, and represents the same structure as the residue obtained by removing the acid dianhydride structure from the tetracarboxylic acid dianhydride. In addition, the “diamine residue” refers to a residue obtained by removing two amino groups from a diamine.

In the general formula (1), R¹ is a tetracarboxylic acid residue, and can be a residue obtained by removing an acid dianhydride structure from a tetracarboxylic acid dianhydride. Examples of the tetracarboxylic acid dianhydride may include materials described in International Publication WO2018/070523. In the general formula (1), R¹ is preferably at least one selected from the group consisting of 4,4′-(hexafluoroisopropylidene) diphthalic acid residue, 3,3′,4,4′-biphenyltetracarboxylic acid residue, pyromellitic acid residue, 2,3′,3,4′-biphenyltetracarboxylic acid residue, 3,3′4,4′-benzophenonetetracarboxylic acid residue, 3,3′4,4′-diphenylsulfonetetracarboxylic acid residue, 4,4′-oxydiphthalic acid residue, cyclohexanetetracarboxylic acid residue, and cyclopentanetetracarboxylic acid residue, and further preferably contains at least one selected from the group consisting of 4,4′-(hexafluoroisopropylidene) diphthalic acid residue, 4,4′-oxydiphthalic acid residue, and 3,3′,4,4′-diphenylsulfone tetracarboxylic acid residue.

In R¹, the total of these suitable residues is preferably 50 mol % or more, more preferably 70 mol % or more, and further more preferably 90 mol % or more.

Also, it is preferable that a tetracarboxylic acid residue group (group A) suitable for improving rigidity such as at least one selected from the group consisting of 3,3′,4,4′-biphenyltetracarboxylic acid residue, 3,3′,4,4′-benzophenone tetracarboxylic acid residue, and pyromellitic acid residue, and a tetracarboxylic acid residue group (group B) suitable for improving transparency such as at least one selected from the group consisting of 4,4′-(hexafluoroisopropylidene)diphthalic acid residue, 2,3′,3,4′ biphenyltetracarboxylic acid residue, 3,3′,4,4′-diphenylsulfonetetracarboxylic acid residue, 4,4′-oxydiphthalic acid residue, cyclohexanetetracarboxylic acid residue, and cyclopentanetetracarboxylic acid residue are mixed and used as R¹.

In this case, the content ratio of the tetracarboxylic acid residue group (group A) suitable for improving the rigidity and the tetracarboxylic acid residue group (group B) suitable for improving transparency is, with respect to 1 mol of a tetracarboxylic acid residue group (group B) suitable for improving transparency, preferably 0.05 mol or more and 9 mol or less of the tetracarboxylic acid residue group (group A) suitable for improving the rigidity, ore preferably 0.1 mol or more and 5 mol or less thereof, and further more preferably 0.3 mol or more and 4 mol or less thereof.

In the general formula (1), R² is preferably at least one divalent group selected from the group consisting of 4,4′-diaminodiphenyl sulfone residue, 3,4′-diaminodiphenyl sulfone residue, and a divalent group represented by the general formula (2) from the point in which transparency is improved and rigidity is improved, and further preferably, at least one divalent group selected from the group consisting of 4,4′-diaminodiphenyl sulfone residue, 3,4′-diaminodiphenyl sulfone residue, and a divalent group represented by the general formula (2) in which R³ and R⁴ are perfluoroalkyl groups.

The R⁵ in the general formula (3) preferably includes a 4,4′-(hexafluoroisopropylidene)diphthalic acid residue, a 3,3′,4,4′-diphenylsulfonetetracarboxylic acid residue, and an oxydiphthalic acid residue from a point in which transparency is improved and rigidity is improved.

In R⁵, it is preferable to include 50 mol % or more of these suitable residues, more preferable to include 70 mol % or more thereof, and further more preferable to include 90 mol % or more thereof.

R⁶ in the general formula (3) is a diamine residue, and can be a residue obtained by removing two amino groups from a diamine. Example of the diamine may include materials described in International Publication WO2018/070523. As R⁶ in the general formula (3), it is preferable to include at least one divalent group selected from the group consisting of 2,2′-bis(trifluoromethyl)benzidine residue, bis [4-(4-aminophenoxy)phenyl]sulfone residue, 4,4′-diaminodiphenyl sulfone residue, 2,2-bis[4-(4-aminophenoxy)phenyl] hexafluoropropane residue, bis [4-(3-aminophenoxy)phenyl] sulfone residue, 4,4′-diamino-2,2′-bis(trifluoromethyl) diphenyl ether residue, 1,4-bis[4-amino-2-(trifluoromethyl)phenoxy] benzene residue, 2,2-bis[4-(4-amino-2-trifluoromethylphenoxy)phenyl] hexafluoropropane residue, 4,4′-diamino-2-(trifluoromethyl) diphenyl ether residue, 4,4′-diaminobenzanilide residue, N,N′-bis(4-aminophenyl)terephthalamide residue, and 9,9-bis(4-aminophenyl)fluorene residue, and further preferable to include at least one divalent group selected from the group consisting of 2,2′-bis(trifluoromethyl)benzidine residue, bis [4-(4-aminophenoxy)phenyl] sulfone residue, and 4,4′-diaminodiphenyl sulfone residue.

In R⁶, the total of these suitable residues is preferably 50 mol % or more, more preferably 70 mol % or more, and more preferably 90 mol % or more.

Also, it is preferable that a diamine residue group (group C) suitable for improving rigidity such as at least one kind selected from the group consisting of bis[4-(4-aminophenoxy)phenyl]sulfone residue, 4,4′-diaminobenzanilide residue, N,N′-bis(4-aminophenyl) terephthalamide residue, paraphenylenediamine residue, meta-phenylenediamine residue, and 4,4′-diaminodiphenylmethane residue, and a diamine residue group (group D) suitable for improving transparency such as at least one kind selected from the group consisting of 2,2′-bis(trifluoromethyl)benzidine residue, 4,4′-diaminodiphenyl sulfone residue, 2,2-bis[4-(4-aminophenoxy)phenyl] hexafluoropropane residue, bis[4-(3-aminophenoxy)phenyl] sulfone residue, 4,4′-diamino-2,2′-bis(trifluoromethyl)diphenyl ether residue, 1,4-bis[4-amino-2-(trifluoromethyl)phenoxy] benzene residue, 2,2-bis [4-(4-amino-2-trifluoromethylphenoxy)phenyl]hexafluoropropane residue, 4,4′-diamino-2-(trifluoromethyl)diphenyl ether residue, and 9,9-bis(4-aminophenyl)fluorene residue are mixed and used as R⁶.

In this case, the content ratio of the diamine residue group (group C) suitable for improving the rigidity and the diamine residue group (group D) suitable for improving transparency is, with respect to 1 mol of the diamine residue group (group D) suitable for improving transparency, 0.05 mol or more and 9 mol or less of the diamine residue group (group C) suitable for improving rigidity, more preferably 0.1 mol or more and 5 mol or less thereof, and further more preferably 0.3 mol or more and 4 mol or less thereof.

In the structure represented by the general formula (1) and the general formula (3), n and n′ each independently represents the number of repeating units, and it is one or more. The number of repeating units n in the polyimide may be appropriately selected according to the structure, and is not particularly limited. The average number of repeating units is, for example, 10 or more and 2000 or less, and preferably 15 or more and 1000 or less.

In addition, the polyimide may include a polyamide structure in a part thereof. Examples of the polyamide structure may include a polyamideimide structure including a tricarboxylic acid residue such as a trimellitic acid anhydride, and a polyamide structure including a dicarboxylic acid residue such as terephthalic acid.

In order to improve transparency and surface hardness, at least one of a tetravalent group which is a tetracarboxylic acid residue of R¹ or R⁵, and a divalent group which is a diamine residue of R² or R⁶ includes an aromatic ring, and preferably includes at least one selected from the group consisting of (i) a fluorine atom, (ii) an aliphatic ring, and (iii) a structure in which aromatic rings are linked by a sulfonyl group or an alkylene group which may be substituted with fluorine. The polyimide contains at least one selected from a tetracarboxylic acid residue having an aromatic ring and a diamine residue having an aromatic ring, so that the molecular skeleton becomes rigid, the orientation is improved, and the surface hardness is improved, but the rigid aromatic ring skeleton tends to extend the absorption wavelength to the long wavelength, and the transmittance of the visible light region tends to decrease. On the other hand, when the polyimide contains (i) a fluorine atom, it is possible to make it difficult to move the electronic state in the polyimide skeleton so as to improve transparency. In addition, when the polyimide contains (ii) an aliphatic ring, it is possible to inhibit the movement of the charge in the skeleton by cutting off the conjugate of pi electrons in the polyimide skeleton, so that transparency is improved. In addition, when the polyimide includes (iii) a structure in which aromatic rings are linked by an alkylene group which may be substituted with a sulfonyl group or fluorine, the transparency is improved from the point where the movement of the charge in the skeleton can be inhibited by cutting off the conjugate of pi electrons in the polyimide skeleton.

In order to improve transparency and surface hardness, at least one of a tetravalent group that is a tetracarboxylic acid residue of R¹ or R⁵, and divalent group that is a diamine residue of R² or R⁶ preferably includes an aromatic ring and a fluorine atom, and it is preferable that a divalent group that is a diamine residue of R² or R⁶ includes an aromatic ring and a fluorine atom.

Specific examples of such polyimide may include those having the specific structure described in International Publication WO2018/070523.

The polyimide can be synthesized by a known method. Also, a commercially available polyimide may be used. Examples of the commercial product of the polyimide include, for example, Neopulim (registered trademark) from Mitsubishi Gas Chemical Company, Inc.

The weight average molecular weight of the polyimide is, for example, preferably 3000 or more and 500,000 or less, more preferably 5000 or more and 300,000 or less, and more preferably 10,000 or more and 200,000 or less. When the weight average molecular weight is too small, sufficient strength may not be obtained, and when the weight average molecular weight is too large, the viscosity increases and the solubility decreases, so that the polyimide substrate having a smooth surface and a uniform thickness may not be obtained.

The weight average molecular weight of the polyimide is measured by gel permeation chromatography (GPC). Specifically, the polyimide is used as an N-methylpyrrolidone (NMP) solution having a concentration of 0.1 mass %, a 30 mmol % LiBr—NMP solution having a water content of 500 ppm or less is used as the deployment solvent, and GPC device from TOSOH CORPORATION (HLC-8120, use column: SHODEX GPC LF-804) is used, and the measurement is performed under the condition of a sample driving amount of 50 μL, and a solvent flow rate of 0.4 mL/min and 37° C. The weight average molecular weight is determined based on a polystyrene standard sample having the same concentration as that of the sample.

### (b) Polyamideimide

The polyamideimide includes, for example, a first block including a constituent unit derived from dianhydride and a constituent unit derived from a diamine, and a second block including a constituent unit derived from an aromatic dicarbonyl compound and a constituent unit derived from an aromatic diamine. In the polyamideimide, the dianhydride can include, for example, biphenyltetracarboxylic dianhydride (BPDA) and 2-bis (3,4-dicarboxyphenyl) hexafluoropropane dianhydride (6FDA). The diamine can also include bistrifluoromethylbenzidine (TFDB). That is, the polyamideimide has a structure obtained by imidizing a polyamideimide precursor having a first block in which a monomer containing dianhydride and a diamine is copolymerized and a second block in which a monomer containing an aromatic dicarbonyl compound and an aromatic diamine is copolymerized. Since the polyamideimide has a first block including an imide bond and a second block including an amide bond, not only optical characteristics but also thermal and mechanical characteristics are excellent. In particular, by using bistrifluoromethylbenzidine (TFDB) as the diamine forming the first block, thermal stability and optical characteristics can be improved. Further, by using 2-bis (3,4-dicarboxyphenyl) hexafluoropropane dianhydride (6FDA) and biphenyltetracarboxylic dianhydride (BPDA) as the dianhydride forming the first block, it is possible to improve birefringence and ensure heat resistance.

The dianhydride forming the first block includes two types of dianhydride, i.e. 6FDA and BPDA. In the first block, a polymer in which TFDB and 6FDA are bonded and a polymer in which TFDB and BPDA are bonded may be included separately on the basis of a separate repeating unit, or may be regularly arranged in the same repeating unit, or may be included in a completely random manner.

Among the monomers forming the first block, it is preferable that BPDA and 6FDA are included in a molar ratio of 1:3 to 3:1 as dianhydride. Not only the securing of the optical characteristics but also the degrade in mechanical characteristics and heat resistance can be suppressed, and it is possible to have excellent birefringence.

The molar ratio of the first block and the second block is preferably 5:1 to 1:1. When the content of the second block is remarkably low, the effect of improving the thermal stability and the mechanical characteristics by the second block may not be sufficiently obtained. In addition, when the content of the second block is higher than the content of the first block, the thermal stability and the mechanical properties can be improved, but the optical characteristics are deteriorated, such as a decrease in yellowness, transmittance, and the like, and the birefringence characteristics may also be increased. The first block and the second block may be a random copolymer and may be a block copolymer. The repeating unit of the block is not particularly limited.

Examples of the aromatic dicarbonyl compound forming the second block include one or more selected from the group consisting of p-terephthaloyl chloride (TPC), terephthalic acid, iso-phthaloyl dichloride, and 4,4′-benzoyl dichloride. Preferably, one or more selected from among p-terephthaloyl chloride (TPC), and iso-phthaloyl dichloride.

As the diamine forming the second block, for example, diamine having one or more flexible groups selected from the group consisting of 2,2-bis(4-(4-aminophenoxy)phenyl) hexafluoropropane (HFBAPP), bis(4-(4-aminophenoxy)phenyl) sulfone (BAPS), bis(4-(3-aminophenoxy)phenyl) sulfone (BAPSM), 4,4′-diaminodiphenylsulfone (4DDS), 3,3′-diaminodiphenyl sulfone (3DDS), 2,2-bis(4-(4-aminophenoxy)phenylpropane (BAPP), 4,4′-diaminodiphenylpropane (6HDA), 1,3-bis(4-aminophenoxy) benzene (134APB), 1,3-bis(3-aminophenoxy) benzene (133 AP B), 1,4-bis(4-aminophenoxy) biphenyl (BAPB), 4,4′-bis(4-amino-2-trifluoromethylphenoxy) biphenyl (6FAPBP), 3,3-diamino-4,4-dihydroxydiphenyl sulfone (DABS), 2,2-bis(3-amino-4-hydroxyloxyphenyl) propane (BAP), 4,4′-diaminodiphenylmethane (DDM), 4,4′-oxydianiline (4-ODA) and 3,3′-oxydianiline (3-ODA) can be exemplified.

When an aromatic dicarbonyl compound is used, it is easy to achieve high thermal stability and mechanical properties, but may exhibit high birefringence by benzene rings in the molecular structure. Therefore, in order to suppress a decrease in birefringence due to the second block, it is preferable that the diamine has a flexible group introduced into the molecular structure. Specifically, the diamine is more preferably one or more diamines selected from bis(4-(3-aminophenoxy)phenyl) sulfone (BAPSM), 4,4′-diaminodiphenyl sulfone (4DDS) and 2,2-bis(4-(4-aminophenoxy)phenyl) hexafluoropropane (HFBAPP). In particular, as the BAPSM, the diamine in which the length of the flexible group is long, and the position of the substituent is at the meta position, exhibits excellent birefringence.

A polyamideimide precursor containing a first block in which a dianhydride containing biphenyltetracarboxylic dianhydride (BPDA) and 2-bis (3,4-dicarboxyphenyl) hexafluoropropane dianhydride (6FDA), and a diamine containing bistrifluoromethylbenzidine (TFDB) are copolymerized, and a second block in which an aromatic dicarbonyl compound and an aromatic diamine are copolymerized, preferably has a weight average molecular weight measured by GPC of, for example, 200,000 or more and 215,000 or less, and has a viscosity of, for example, 2400 poise or more and 2600 poise or less.

The polyamideimide can be obtained by imidizing the polyamideimide precursor. In addition, a polyamideimide film can be obtained using polyamideimide. For a method for imidizing a polyamideimide precursor and a method for producing a polyamideimide film, for example, Japanese Patent Unexamined Application (JP-A) No. 2018-506611 can be referred to.

### (2) the Configuration of a Resin Substrate

The thickness of the resin substrate is not particularly limited as long as it is possible to have flexibility. The thickness of the resin substrate is, for example, preferably 10 μm or more and 100 μm or less, and more preferably 25 μm or more and 80 μm or less. When the thickness of the resin substrate is within the above range, sufficient hardness can be obtained as well as good flexibility can be obtained. In addition, curling of the layered body can also be suppressed. Furthermore, it is preferable in terms of reducing the weight of the layered body.

The indentation hardness of the resin substrate is preferably greater than each of the indentation hardness of the first intermediate layer and the indentation hardness of the second intermediate layer. The bending resistance of the layered body is improved.

The indentation hardness of the resin substrate is preferably greater than each of the indentation hardness of the first intermediate layer and the indentation hardness of the second intermediate layer, and may be, for example, 240 MPa or more and 600 MPa or less, may be 280 MPa or more and 550 MPa or less, and may be 300 MPa or more and 500 MPa or less.

The method for measuring the indentation hardness of the resin substrate is the same as the method for measuring the indentation hardness of the first intermediate layer described later.

Here, in the measurement of the indentation hardness, in order to avoid the influence of the optical resin layer and to avoid the influence of the side edge of the resin substrate when an intender is pushed into the center of the cross-section of the resin substrate, Berkovich indenter is pushed into the portion of the resin substrate separated from the interface of the resin substrate and the second intermediate layer by 500 nm or more to the center side of the resin substrate, and separated from both side ends of the resin substrate by 500 nm or more from both side ends of the resin substrate to the center side of the resin substrate. In a case where an arbitrary layer is disposed on the surface of the resin substrate that is opposite side to the optical resin layer, the Berkovich indenter is pushed into the portion of the resin substrate separated by 500 nm or more from the interface between the resin substrate and the arbitrary layer to the center side of the resin substrate.

Also, in the measurement of the indentation hardness of the resin substrate, a measurement sample may be prepared for the layered body, and a measurement sample may be prepared only for the resin substrate.

### 2. Optical Resin Layer

The optical resin layer in the present embodiment is a member disposed on a surface opposite to the second intermediate layer of the first intermediate layer.

### (1) Material of Optical Resin Layer

The optical resin layer in the present embodiment may have a hard coat property, for example, or may not have a hard coat property. Among them, the optical resin layer preferably has a hard coat property. That is, the optical resin layer is preferably a hard coat layer.

Here, the optical resin layer having the hard coat property is a layer for improving surface hardness. Specifically, in the optical resin layer side surface of the layered body, it is one having a hardness of “H” or more in a pencil hardness test specified in JIS K 5600-5-4: 1999.

When the optical resin layer has a hard coat property, the optical resin layer preferably contains, for example, a cured product of a resin composition containing a polymerizable compound. A cured product of a resin composition containing a polymerizable compound can be obtained by using a polymerization initiator as needed to polymerize the polymerizable compound in a known method.

The polymerizable compound includes at least one polymerizable functional group in the molecule. As the polymerizable compound, for example, at least one of a radical polymerizable compound and a cation polymerizable compound can be used.

The radical polymerizable compound is a compound including a radical polymerizable group. The radical polymerizable group of the radical polymerizable compound may be a functional group capable of generating a radical polymerization reaction, and is not particularly limited. For example, a group including a carbon-carbon unsaturated double bond may be exemplified. Specifically, a vinyl group and a (meth)acryloyl group are exemplified. When the radical polymerizable compound includes two or more radical polymerizable groups, these radical polymerizable groups may be the same or different.

The number of radical polymerizable groups included in one molecule of the radical polymerizable compound is preferably two or more from the point in which the surface hardness of the optical resin layer increases and the scratch resistance is improved, and more preferably three or more.

The radical polymerizable compound is preferably a compound including a (meth)acryloyl group from the point of the height of the reactivity. For example, a polyfunctional (meth)acrylate monomer and a polyfunctional (meth)acrylate oligomer including several (meth)acryloyl groups in the molecule and having several hundreds to thousands of molecular weight are preferable. Also, a polyfunctional (meth)acrylate polymer including two or more (meth)acryloyl groups in the side chain of the acrylate polymer is also preferable. Examples of the polyfunctional (meth)acrylate monomer and the polyfunctional (meth)acrylate oligomer include urethane (meth)acrylate, polyester (meth)acrylate, epoxy (meth)acrylate, melamine (meth)acrylate, polyfluoroalkyl (meth)acrylate, and silicone (meth)acrylate.

Among them, a polyfunctional (meth)acrylate monomer including two or more (meth)acryloyl groups in one molecule is preferable. Since the optical resin layer contains a cured product of a resin composition containing a polyfunctional (meth)acrylate monomer, it is possible to increase the surface hardness of the optical resin layer and improve scratch resistance. Furthermore, close adhesion can also be improved. A polyfunctional (meth)acrylate oligomer or polyfunctional (meth)acrylate polymer including two or more (meth)acryloyl groups in one molecule is also preferable. The optical resin layer contains a cured product of a resin composition containing a polyfunctional (meth)acrylate oligomer or a polyfunctional (meth)acrylate polymer, and thus surface hardness of the optical resin layer is increased and scratch resistance is improved. Further, bending resistance and close adhesion can also be improved.

In this specification, the (meth)acryloyl represents each of acryloyl and methacryloyl. In addition, the (meth)acrylate represents each of acrylate and methacrylate.

In particular, a polyfunctional (meth)acrylate monomer including 3 or more and 6 or less (meth)acryloyl groups in one molecule is preferable. The reactivity is high, and thus the surface hardness of the optical resin layer is increased, and the scratch resistance is improved.

Also, a monofunctional (meth)acrylate monomer may be further used as the radical polymerizable compound for hardness adjustment, viscosity adjustment, adhesion improvement, and the like.

The cation polymerizable compound is a compound including a cation polymerizable group. The cation polymerizable group of the cation polymerizable compound may be a functional group capable of generating a cation polymerization reaction, and is not particularly limited. For example, an epoxy group, an oxetanyl group, and a vinyl ether group are exemplified. When the cation polymerizable compound includes two or more cation polymerizable groups, these cation polymerizable groups may be the same or different.

The number of cation polymerizable groups in one molecule of the cation polymerizable compound is preferably two or more, and more preferably three or more because the surface hardness of the optical resin layer is increased and the scratch resistance is improved.

The cation polymerizable compound is preferably a compound including at least one of an epoxy group and an oxetanyl group as a cation polymerizable group, and more preferably a compound including two or more of at least one of epoxy groups and oxetanyl groups in one molecule.

In addition, when the optical resin layer does not have a hard coat property, the optical resin layer includes, for example, a thermoplastic resin, a cured resin, and the like. The cured resin refers to a resin cured by heat, or a resin cured by irradiation with ionizing radiation such as ultraviolet rays or electron beams.

The optical resin layer may contain a polymerization initiator as needed. As the polymerization initiator, a radical polymerization initiator, a cation polymerization initiator, a radical and cation polymerization initiator, and the like can be appropriately selected and used. In the optical resin layer, all of the polymerization initiator may be decomposed and not remained.

In addition, the optical resin layer may contain an ultraviolet absorber. The content of the ultraviolet absorber in the optical resin layer is preferably 10 parts by mass or less with respect to 100 parts by mass of the resin component, more preferably 5 parts by mass or less, and further more preferably 1 parts by mass or less. If the content of the ultraviolet absorber in the optical resin layer is too much, the curing failure of the optical resin layer may occur. As a result, the surface hardness of the optical resin layer may decrease.

Among them, the optical resin layer preferably does not substantially contain an ultraviolet absorber. Curing failure of the optical resin layer by the ultraviolet absorber can be suppressed. Note that when the optical resin layer does not substantially contain the ultraviolet absorber, the content of the ultraviolet absorber in the optical resin layer is 0.5 parts by mass or less with respect to 100 parts by mass of the resin component. In particular, it is preferable that the content of the ultraviolet absorber is 0 parts by mass and the optical resin layer does not contain an ultraviolet absorber.

In addition, the optical resin layer can contain an additive as needed. Examples of the additive include inorganic particles, organic particles, an antioxidant, a light stabilizer, an infrared absorbent, an antistatic agent, an antifouling agent, an anti-glare agent, a leveling agent, a surfactant, an easy lubricant, various sensitizers, a flame retardant, an adhesion-imparting agent, a polymerization inhibitor, and a surface modifier.

Each component included in the optical resin layer can be analyzed by, for example, a Fourier transform infrared spectrophotometer (FTIR), a pyrolysis gas chromatograph device (GC-MS), a high-speed liquid chromatography, a gas chromatograph mass spectrometer, an NMR, an elemental analysis, an XPS/ESCA, a TOF-SIMS, and combinations thereof.

In addition, the optical resin layer may contain a first component configuring the resin substrate. When the resin substrate is configured by a plurality of components, the first intermediate layer can contain at least one component of the constituent components of the resin substrate. Note that the first component will be described later.

When the content of the first component in the resin substrate is 100%, the ratio of the content of the first component in the optical resin layer to the content of the first component in the resin substrate is preferably 0% or more and 10% or less, for example. If the ratio is within the above range, deterioration of characteristics of the optical resin layer due to the first component, in particular, degrade in hardness characteristics can be suppressed.

Here, the ratio of the content of the first component in the optical resin layer to the content of the first component in the resin substrate is obtained by measuring the cross-section of the layered body by the AFM-IR method (AFM-based Infrared Ray Spectroscopy). With respect to the intensity of the peak derived from the first component in the IR spectrum of the resin substrate, the ratio of the intensity of the peak derived from the first component in the IR spectrum of the optical resin layer to the intensity of the peak derived from the first component in the IR spectrum of the resin substrate can be regarded as the ratio of the content of the first component in the optical resin layer to the content of the first component in the resin substrate.

In an AFM-IR method, first, the characteristic peaks of the resin substrate and the optical resin layer are respectively confirmed from the IR spectrum of the resin substrate and the optical resin layer.

For example, when the optical resin layer contains a cured product of a resin composition containing a polymerizable compound including a (meth)acryloyl group, the peak derived from C═O stretching vibration of the ester group appears at 1725±20 cm⁻¹, and the peak derived from C—O stretching vibration of the ester group appears at 1145±20 cm⁻¹.

The characteristic peak derived from the resin substrate varies with the constituent components of the resin substrate. For example, when the resin substrate contains a polyester-based resin, a peak derived from C═O stretching vibration of the ester group appears at 1715±20 cm⁻¹, a peak derived from C—O stretching vibration of the aromatic ester group appears at 1240±20 cm⁻¹, and a peak derived from C—O stretching vibration of the ester group appears at 1095±20 cm⁻¹. In addition, for example, when the resin substrate contains a polyamide-based resin, a peak derived from C═O stretching vibration of the amide group appears at 1635±20 cm⁻¹, a peak derived from a —C—N—H deformation vibration of the amide group appears at 1540±20 cm⁻¹, and a peak derived from C—N stretching vibration of the amide group appears at 1265±20 cm⁻¹. For example, when the resin substrate contains a polyimide-based resin, a peak derived from C═O stretching vibration of the imide group appears at 1725±20 cm⁻¹, and a peak derived from C—N stretching vibration of the imide group appears at 1366±20 cm⁻¹.

In this way, the characteristic peaks vary with the resin substrate and the optical resin layer. Therefore, by determining the ratio of the intensity of the peak in the IR spectrum of the optical resin layer with reference to the intensity of the peak derived from the resin substrate, the ratio of the content of the first component in the optical resin layer to the content of the first component in the resin substrate can be determined.

As described above, for example, when the resin substrate contains a polyester-based resin, a peak (1715±20 cm⁻¹) derived from C═O stretching vibration of the ester group, a peak (1240±20 cm⁻¹) derived from C—O stretching vibration of the aromatic ester group, and a peak (1095±20 cm⁻¹) derived from the C—O stretching vibration of the ester group appear. Among them, a peak (1715±20 cm⁻¹) derived from C═O stretching vibration of the ester group is easily analyzed. Therefore, it is preferable to determine the ratio of the intensity of the peak (1715±20 cm⁻¹) derived from the C═O stretching vibration of the ester group. When the peak (1715±20 cm⁻¹) derived from C═O stretching vibration of the ester group is hard to identify, the ratio of the intensity of the peak (1240±20 cm⁻¹) derived from the C—O stretching vibration of the aromatic ester group may be determined. In addition, when the peak (1240±20 cm⁻¹) derived from the C—O stretching vibration of the aromatic ester group is hard to be identified, the ratio of the intensity of the peak of the peak (1095±20 cm⁻¹) derived from the C—O stretching vibration of the ester group may be determined.

Also, as described above, for example, when the resin substrate contains a polyamide-based resin, a peak (1635±20 cm⁻¹) derived from C═O stretching vibration of the amide group, a peak (1540±20 cm⁻¹) derived from the —C—N—H deformation vibration of the amide group, and a peak (1265±20 cm⁻¹) derived from the C—N stretching vibration of the amide group appear. Among them, a peak (1635±20 cm⁻¹) derived from C═O stretchable vibration of the amide group is easily analyzed. Therefore, it is preferable to determine the ratio of the intensity of the peak (1635±20 cm⁻¹) derived from the C═O stretching vibration of the amide group. When the peak (1635±20 cm⁻¹) derived from the C═O stretching vibration of the amide group is hard to identify, the ratio of the intensity of the peak (1540±20 cm⁻¹) derived from the —C—N—H deformation vibration of the amide group may be determined. In addition, when the peak (1540±20 cm⁻¹) derived from the —C—N—H deformation vibration of the amide group is not easily identified, the ratio of the intensity of the peak (1265±20 cm⁻¹) derived from the C—N stretching vibration of the amide group may be determined.

Also, as described above, for example, when the resin substrate contains a polyimide-based resin, a peak (1725±20 cm⁻¹) derived from C═O stretching vibration of the imide group and a peak (1366±20 cm⁻¹) derived from C—N stretching vibration of the imide group appear. Among them, a peak (1725±20 cm⁻¹) derived from C═O stretching vibration of the imide group is easily analyzed.

Therefore, it is preferable to determine the ratio of the intensity of the peak (1725±20 cm⁻¹) derived from the C═O stretching vibration of the imide group. When the peak (1725±20 cm⁻¹) derived from C═O stretching vibration of the imide group is difficult to identify, the ratio of the intensity of the peak (1366±20 cm⁻¹) derived from the C—N stretching vibration of the imide group may be determined.

The AFM-IR measurement is performed using nanoIR from Anays Instruments company. Specific examples of measurement conditions are shown.
Light source: Tunable pulsed laser (1 kHz)
AFM mode: contact mode (AFM-IR spectrum acquisition)
Measurement wave number range: 1950 cm⁻¹ to 950 cm⁻¹
Wave number resolution: 1.5 cm⁻¹
Coverages: 512
Integrated number of times: three or more times
Polarization angle: 45 degrees

### (2) Constitution of Optical Resin Layer

The optical resin layer may be a single layer or may be multi-layer.

Further, when the optical resin layer has a hard coat property and the optical resin layer is multi-layer, the optical resin layer may include a first hard coat layer and a second hard coat layer in order from the first intermediate layer side. In this case, in order to improve the surface hardness and improve the bending resistance, the optical resin layer may include, in order from the first intermediate layer side, a first hard coat layer for imparting hardness, and a second hard coat layer for imparting bending resistance and scratch resistance.

The thickness of the optical resin layer is appropriately selected according to the function of the optical resin layer and the applications of the layered body. The thickness of the optical resin layer is, for example, preferably 1 μm or more and 20 μm or less, more preferably 1 μm or more and 15 μm or less, and further more preferably 2 μm or more and 5 μm or less. If the thickness of the optical resin layer is too thin, a desired function may not be obtained. In addition, if the thickness of the optical resin layer is too thick, flexibility and bending resistance may be reduced.

Here, the thickness of the optical resin layer is measured after the first intermediate layer and the second intermediate layer are dyed with a dyeing agent in a cross section in the thickness direction of the layered body, so that the interface between the first intermediate layer and the optical resin layer can be observed. Specifically, the thickness of the optical resin layer is an average value of the thickness of any 10 points obtained by measuring from the cross section in the thickness direction of the layered body observed by the scanning transmission electron microscope (STEM). The same applies to a method for measuring the thickness of other layers of the layered body unless otherwise specified.

The indentation hardness of the optical resin layer is preferably greater than the indentation hardness of the resin substrate. The hardness characteristics of the layered body are improved.

The indentation hardness of the optical resin layer is preferably greater than each of the indentation hardness of the first intermediate layer and the indentation hardness of the second intermediate layer. The hardness characteristics and the bending resistance of the layered body are improved.

The indentation hardness of the optical resin layer is preferably greater than each of the indentation hardness of the first intermediate layer and the indentation hardness of the second intermediate layer, and preferably 400 MPa or more, more preferably 400 MPa or more and 1500 MPa or less, and further more preferably 400 MPa or more and 800 MPa or less. Since the indentation hardness of the optical resin layer is within the above range, the surface hardness can be improved.

The method for measuring the indentation hardness of the optical resin layer is the same as the method for measuring the indentation hardness of the first intermediate layer described later.

Here, in the measurement of the indentation hardness, in order to avoid the influence of the resin substrate and avoid the influence of the side edge of the optical resin layer when an indenter is pushed in the center of the optical resin layer, the Berkovich indenter is pushed in the center of the optical resin layer separated from the interface between the optical resin layer and the first intermediate layer to the center side of the resin substrate by 500 nm or more, and from both side ends of the optical resin layer to the center side of the optical resin layer by 500 nm or more.

In addition, in the measurement of the indentation hardness of the optical resin layer, a measurement sample may be prepared for the layered body, and the measurement sample may be prepared only for the optical resin layer.

Examples of the method for forming the optical resin layer include a method for applying and curing a resin composition for an optical resin layer.

### 3. First Intermediate Layer

The first intermediate layer in the present embodiment is disposed between the optical resin layer and the second intermediate layer, and contains a first component configuring the resin substrate.

The first intermediate layer contains a first component configuring the resin substrate. In addition, when the resin substrate is configured by a plurality of components, the first intermediate layer may contain at least one component of the constituent components of the resin substrate.

The first component is not particularly limited as long as it is a constituent component of the resin substrate, but it is preferable that the first component is a resin component configuring the resin substrate. Specifically, the first component is preferably a resin including at least one selected from the group consisting of an imide skeleton, an amide skeleton, and an ester skeleton, and more preferably a resin including at least an imide skeleton. More specifically, the first component is preferably a polyimide-based resin, a polyamide-based resin, or a polyester-based resin, and more preferably a polyimide-based resin. The close adhesion between the resin substrate and the optical resin layer can be improved. Furthermore, the close adhesion between the resin substrate and the optical resin layer can be maintained even after exposure to ultraviolet rays.

The ratio of the content of the first component in each layer to the content of the first component in the resin substrate is preferably greater in the order of the optical resin layer, the first intermediate layer, the second intermediate layer, and the resin substrate. In this case, the ratio of the content of the first component in the first intermediate layer to the content of the first component in the resin substrate may be equal to or less than the ratio of the content of the first component in the second intermediate layer to the content of the first component in the resin substrate. That is, the magnitude relationship of the ratio is preferably an optical resin layer<a first intermediate layer≤a second intermediate layer<a resin substrate. The close adhesion between the resin substrate and the optical resin layer can be improved. Furthermore, the close adhesion between the resin substrate and the optical resin layer can be maintained even after exposure to ultraviolet rays.

When the content of the first component in the resin substrate is 100%, the ratio of the content of the first component in the first intermediate layer to the content of the first component in the resin substrate may be in the specified magnitude relation of the ratio, and for example, preferably 10% or more and 50% or less, more preferably 15% or more and 40% or less, and further more preferably 20% or more and 30% or less. Here, when the difference in the content of the first component is large between the optical resin layer and the first intermediate layer, the difference in hardness tends to increase. When the difference in hardness is large between the optical resin layer and the first intermediate layer, the bending resistance may decrease. If the ratio is within the above range, the difference in the content of the first component can be made relatively small between the optical resin layer and the first intermediate layer, and the difference in hardness can be made relatively small. Therefore, the bending resistance can be improved.

Here, the ratio of the content of the first component in the first intermediate layer to the content of the first component in the resin substrate is determined by measuring the cross-section of the layered body by the AFM-IR method (AFM-based Infrared Spectroscopy). On the basis of the intensity of the peak derived from the first component in the IR spectrum of the resin substrate, the ratio of the intensity of the peak derived from the first component in the IR spectrum of the first intermediate layer to the intensity of the peak derived from the first component in the IR spectrum of the resin substrate can be regarded as the ratio of the content of the first component in the first intermediate layer to the content of the first component in the resin substrate.

In the case of the AFM-IR method, first, a characteristic peak is confirmed from the IR spectrum of the resin substrate. A characteristic peak derived from the resin substrate varies with the constituent components of the resin substrate.

For example, when the resin substrate contains a polyester-based resin, a peak derived from C═O stretching vibration of the ester group appears at 1715±20 cm⁻¹, a peak derived from C—O stretching vibration of the aromatic ester group appears at 1240±20 cm⁻¹, and a peak derived from C—O stretching vibration of the ester group appears at 1095±20 cm⁻¹. Among them, a peak (1715±20 cm⁻¹) derived from C═O stretching vibration of the ester group is easily analyzed. Therefore, it is preferable to determine the ratio of the intensity of the peak (1715±20 cm⁻¹) derived from the C═O stretch vibration of the ester group. When the peak (1715±20 cm⁻¹) derived from C═O stretching vibration of the ester group is hard to identify, the ratio of the intensity of the peak (1240±20 cm⁻¹) derived from the C—O stretching vibration of the aromatic ester group may be determined. In addition, when the peak (1240±20 cm⁻¹) derived from the C—O stretching vibration of the aromatic ester group is hard to be identified, the ratio of the intensity of the peak of the peak (1095±20 cm⁻¹) derived from the C—O stretching vibration of the ester group may be determined.

In addition, for example, when the resin substrate contains a polyamide-based resin, a peak derived from C═O stretching vibration of the amide group appears at 1635±20 cm⁻¹, a peak derived from —C—N—H deformation vibration of amide group appears at 1540±20 cm⁻¹, a peak derived from C—N stretching vibration of the amide group appears at 1265±20 cm⁻¹. Among them, a peak (1635±20 cm⁻¹) derived from C═O stretchable vibration of the amide group is easily analyzed. Therefore, it is preferable to determine the ratio of the intensity of the peak (1635±20 cm⁻¹) derived from the C═O stretching vibration of the amide group. When the peak (1635±20 cm⁻¹) derived from the C═O stretching vibration of the amide group is hard to identify, the ratio of the intensity of the peak (1540±20 cm⁻¹) derived from the —C—N—H deformation vibration of the amide group may be determined. In addition, when the peak (1540±20 cm⁻¹) derived from the —C—N—H deformation vibration of the amide group is not easily identified, the ratio of the intensity of the peak (1265±20 cm⁻¹) derived from the C—N stretching vibration of the amide group may be determined.

In addition, for example, when the resin substrate contains a polyimide-based resin, the peak derived from the C═O stretching vibration of the imide group appears at 1725±20 cm⁻¹ and the peak derived from the C—N stretching vibration of imide group appears at 1366±20 cm⁻¹. Among them, a peak (1725±20 cm⁻¹) derived from C═O stretching vibration of the imide group is easily analyzed. Therefore, it is preferable to determine the ratio of the intensity of the peak (1725±20 cm⁻¹) derived from the C═O stretching vibration of the imide group. When the peak (1725±20 cm⁻¹) derived from the C═O stretching vibration of the imide group is difficult to identify, the ratio of the intensity of the peak (1366±20 cm⁻¹) derived from the C—N stretching vibration of the imide group may be determined.

The AFM-IR measurement is performed using nanoIR from Anays Instruments company. Specific examples of measurement conditions are shown.
Light source: tunable pulse laser (1 kHz)
AFM mode: contact mode (AFM-IR spectrum acquisition)
Measurement wave number range: 1950 cm⁻¹ to 950 cm⁻¹
Wave number resolution: 1.5 cm⁻¹
Coverage: 512
Integrated number of times: three or more times
Polarization angle: 45 degrees

The method for measuring the ratio of the content of the first component in the second intermediate layer with respect to the content of the first component in the resin substrate is also the same as the above.

The first intermediate layer preferably contains a second component configuring the optical resin layer. When the optical resin layer is configured by a plurality of components, the first intermediate layer preferably contains at least one component of the constituent components of the optical resin layer. The close adhesion between the resin substrate and the optical resin layer can be improved. In addition, bending resistance can be improved. When the optical resin layer is multi-layer, the second component configuring the optical resin layer is a constituent component of a layer adjacent to the first intermediate layer among the layers configuring the optical resin layer.

The second component is not particularly limited as long as it is the constituent component of the optical resin layer. Among them, the second component is preferably a polymer of a polymerizable compound. When the optical resin layer contains a plurality of polymerizable compounds, the second component may be a polymer of at least one polymerizable compound. The close adhesion between the resin substrate and the optical resin layer can be improved. In addition, bending resistance can be improved.

It is confirmed that the first intermediate layer contains a second component by measuring the cross section of the layered body by AFM-IR method (AFM-based Infrared Spectroscopy).

Here, a hardness characteristic is required in addition to close adhesion and bending resistance in a layered body including an optical resin layer including various performances and disposed on the surface of the display device and the touch panel. In order to satisfy certain hardness characteristics, in general, the hardness of the optical resin layer is often designed to be greater than the hardness of the resin substrate. However, when the optical resin layer of high hardness is disposed in contact with the resin substrate, the greater the hardness difference between the optical resin layer and the resin substrate, the more the bending resistance tends to decrease. Therefore, in order to release the stress applied to the layered body at the time of bending, the balance of the hardness of each layer configuring the layered body is important. From the relationship of the ratio between the thicknesses of the layers, it can be said that the influence of the resin substrate is large. Therefore, it is considered that it is important to arrange a flexible intermediate layer that follows the resin substrate and mitigates stress between the resin substrate and the optical resin layer. Specifically, the intermediate layer preferably has an intermediate hardness between the hardness of the resin substrate and the hardness of the optical resin layer, or the intermediate layer is preferably softer than the resin substrate and the optical resin layer. Note that, when the intermediate layer is softer than the resin substrate and the optical resin layer, the intermediate layer preferably has a hardness such that the hardness characteristics of the layered body do not decrease.

Therefore, when the indentation hardness of the optical resin layer is greater than the indentation hardness of the resin substrate, the indentation hardness of the first intermediate layer is preferably greater than the indentation hardness of the resin substrate and smaller than the indentation hardness of the optical resin layer, or the indentation hardness of the first intermediate layer is preferably smaller than each of the indentation hardness of the resin substrate and the indentation hardness of the optical resin layer. The hardness characteristics and the bending resistance of the layered body are improved. Among them, if the indentation hardness of the optical resin layer is greater than the indentation hardness of the resin substrate, the indentation hardness of the first intermediate layer is more preferably smaller than each of the indentation hardness of the resin substrate and the indentation hardness of the optical resin layer.

Further, the indentation hardness of the first intermediate layer is preferably smaller than each of the indentation hardness of the resin substrate and the indentation hardness of the optical resin layer. The bending resistance of the layered body is improved.

The indentation hardness of the first intermediate layer is preferably smaller than each of the indentation hardness of the resin substrate and the indentation hardness of the optical resin layer, and for example, preferably 100 MPa or more and 400 MPa or less, more preferably 200 MPa or more and 390 MPa or less, and further more preferably 300 MPa or more and 380 MPa or less. Since the indentation hardness of the first intermediate layer is within the above range, both the close adhesion between the resin substrate and the optical resin layer and the bending resistance of the layered body can be improved.

As described above, the intermediate layer preferably has an intermediate hardness between the hardness of the resin substrate and the hardness of the optical resin layer, or the intermediate layer is preferably softer than the resin substrate and the optical resin layer. In this case, the hardness of the intermediate layer is preferably close to the hardness of the resin substrate in order to increase the followability of the intermediate layer with respect to the resin substrate.

Therefore, the difference between the indentation hardness of the first intermediate layer and the indentation hardness of the resin substrate is preferably smaller than the difference between the indentation hardness of the first intermediate layer and the indentation hardness of the optical resin layer. In this case, the indentation hardness of the first intermediate layer is closer value to the indentation hardness of the resin substrate than the indentation hardness of the optical resin layer. As a result, both the close adhesion between the resin substrate and the optical resin layer and the bending resistance of the layered body can be improved.

In particular, the indentation hardness of the first intermediate layer is preferably smaller than each of the indentation hardness of the resin substrate and the indentation hardness of the optical resin layer, and the difference between the indentation hardness of the first intermediate layer and the indentation hardness of the resin substrate is preferably smaller than the difference between the indentation hardness of the first intermediate layer and the indentation hardness of the optical resin layer. The close adhesion between the resin substrate and the optical resin layer, the hardness characteristics of the layered body, and the bending resistance of the layered body can be improved. In this case, the indentation hardness of the optical resin layer will necessarily be greater than the indentation hardness of the resin substrate.

The difference between the indentation hardness of the first intermediate layer and the indentation hardness of the resin substrate is, for example, 200 MPa or less, may be 150 MPa or less, may be less than 120 MPa, or may be 100 MPa or less.

The difference between the indentation hardness of the first intermediate layer and the indentation hardness of the optical resin layer is 200 MPa or less, may be 150 MPa or less, may be less than 120 MPa, or may be 100 MPa or less.

Among them, the difference between the indentation hardness of the first intermediate layer and the indentation hardness of the resin substrate, and the difference between the indentation hardness of the first intermediate layer and the indentation hardness of the optical resin layer are preferably respectively less than 120 MPa. Both the close adhesion between the resin substrate and the optical resin layer and the bending resistance of the layered body can be improved.

The difference between, the difference between the indentation hardness of the first intermediate layer and the indentation hardness of the resin substrate and the difference between the indentation hardness of the first intermediate layer and the indentation hardness of the optical resin layer is preferably 30 MPa or less, for example. Both the close adhesion between the resin substrate and the optical resin layer and the bending resistance of the layered body can be improved.

In particular, the indentation hardness of the first intermediate layer is smaller than each of the indentation hardness of the resin substrate and the indentation hardness of the optical resin layer, and the difference between the indentation hardness of the first intermediate layer and the indentation hardness of the resin substrate is smaller than the difference between the indentation hardness of the first intermediate layer and the indentation hardness of the optical resin layer, and the difference between the indentation hardness of the first intermediate layer and the indentation hardness of the resin substrate and the difference between the indentation hardness of the first intermediate layer and the indentation hardness of the optical resin layer is respectively less than 120 MPa, and the difference between, the difference between the indentation hardness of the first intermediate layer and the indentation hardness of the resin substrate, and the difference between the indentation hardness of the first intermediate layer and the indentation hardness of the optical resin layer is preferably 30 MPa or less. The close adhesion between the resin substrate and the optical resin layer, the hardness characteristics of the layered body, and the bending resistance of the layered body can be improved. In this case, as described above, the indentation hardness of the optical resin layer will necessarily be greater than the indentation hardness of the resin substrate.

Note that the “indentation hardness” is a value obtained from the load-displacement curve from the load of the indenter to the unloading obtained by the hardness measurement by the nanoindentation method.

Indentation hardness (H_{IT}) measurement is performed using “Hysitron TI950 TriboIndenter” manufactured by BRUKER. Specifically, first, the layered body is cut into 1 mm*10 mm, and a block embedded with an embedding resin is produced. Next, by a general section production method, a section having a thickness of 50 nm or more and 100 nm or less without holes or the like is cut out from this block. For the preparation of sections, for example, “Ultramicrotome EM UC7” (manufactured by Leica Microsystems) is used. Then, the remaining block from which this section is cut out is used as a measurement sample. Next, in the cross-section obtained by cutting out the section in such a measurement sample, the indenter is pressed vertically into the center of the cross-section of the first intermediate layer under the following measurement conditions. As an indenter, a Berkovich indenter (triangular pyramid, “TI-0039” manufactured by BRUKER) is used. Here, in order to avoid the influence of the resin substrate and the optical resin layer, Berkovich indenter is pushed in a portion of the first intermediate layer in a distance of 300 nm or more from the interface between the first intermediate layer and the layer adjacent to the first intermediate layer to the center side of the first intermediate layer, and the center of the thickness of the first intermediate layer, and to avoid the influence of the side edge of the first intermediate layer, respectively, from both ends of the first intermediate layer to the center side of the first intermediate layer by 500 nm or more. Next, after holding a constant level and relaxing the residual stress, the load is removed and the maximum load after relaxation is measured. And the maximum load Pₘₐₓ and contact projection area Aₚ are used, and the indentation hardness (H_{IT}) is calculated from Pₘₐₓ/Aₚ. The contact projection area Aₚ is the contact projection area obtained by correcting the curvature of the indenter tip by the Oliver-Pharr method using a standard sample of fused quartz (“5-0098” manufactured by BRUKER).

The indentation hardness (H_{IT}) is an arithmetic mean value of values obtained by measuring ten points. In a case where a value out of ±20% or more from the arithmetic average value is included in the measurement value, the measurement value is excluded and re-measurement is performed. Whether or not a value out of ±20% or more from the arithmetic average value exists in the measurement value is defined by whether the value (%) obtained by (A−B)/B*100, in which A is the measurement value and B is the arithmetic average value, is ±20% or more or not. The indentation hardness (H_{IT}) can be adjusted by the constituent components of the resin substrate and the constituent components of the optical resin layer.

### (Measurement Conditions of Indentation Hardness)

Push-in control system: Displacement control system
Indentation depth: 100 nm
Push-in speed: 10 nm/second
Load time: 20 seconds
Retention time: 5 seconds
Load unloading speed: 10 nm/second
Load removal time: 20 seconds
Measurement temperature: 25° C.

Examples of the method for forming the first intermediate layer include a method of applying a first intermediate layer resin composition containing a first component and an arbitrary second component on the second intermediate layer.

The thickness of the first intermediate layer is not particularly limited as long as the close adhesion of the resin substrate and the optical resin layer is obtained, and for example, it is preferably 1 μm or more and 5 μm or less, more preferably 2 μm or more and 5 μm or less, and further more preferably 2 μm or more and 4 μm or less. If the thickness of the first intermediate layer is too thin, the close adhesion between the resin substrate and the optical resin layer may be insufficient. In addition, when the thickness of the first intermediate layer is too thick, the thickness of the entire layered body increases, and therefore, the bending resistance of the layered body tends to decrease.

Here, the thickness of the first intermediate layer is obtained by dyeing the first intermediate layer with a dyeing agent in a cross section in the thickness direction of the layered body, and measuring the thickness of the dyed first intermediate layer. The dyeing agent is, for example, at least one selected from the group consisting of ruthenium tetraoxide, osmium tetraoxide, and tungsten phosphate.

At least one selected from the group consisting of ruthenium tetraoxide, osmium tetraoxide, and tungsten phosphate has a large molecular mobility such as an amorphous portion, enters a low-density portion, and easily reacts. When the content of the first component in the first intermediate layer is less than the content of the first component in the resin substrate, the first intermediate layer has a low density of the first component configuring the resin substrate and becomes a low-density region. In addition, even when the ratio of the content of the first component in each layer to the content of the first component in the resin substrate increases in the order of the first intermediate layer, the second intermediate layer, and the resin substrate, the first intermediate layer has a low density of the first component configuring the resin substrate and becomes a low-density region. It is believed that at least one selected from the group consisting of ruthenium tetraoxide, osmium tetraoxide and tungsten phosphate adheres to the low-density region to selectively dye the first intermediate layer.

The dyeing agent is appropriately selected according to the constituent components of the resin substrate. When the resin substrate contains a resin including at least an imide skeleton, the dyeing agent is preferably at least one selected from ruthenium tetraoxide and osmium tetraoxide, and ruthenium tetraoxide is more preferable. When the resin substrate contains a resin including at least an amide skeleton, the dyeing agent is preferably tungsten phosphate. When the resin substrate contains a resin including at least an ester skeleton, the dyeing agent is preferably ruthenium tetraoxide.

Examples of the method for dyeing the first intermediate layer with the dyeing agent in the cross-section in the thickness direction of the layered body include the following method. First, the layered body is cut out into a strip shape of 2 mm*10 mm. Then, the sample is wrapped and solidified by the resin and fixed. Subsequently, the thickness direction of the fixed sample is cut at a width of about 50 nm or more and 150 nm or less using microtome to produce an ultrathin section. Then, the ultrathin section is put in the container together with the dyeing agent and sealed, and left for a fixed time at a room temperature (25° C.). In this way, the first intermediate layer is dyed with the dyeing agent. The leaving time is not particularly limited, and is appropriately adjusted. The leaving time is, for example, 10 minutes or more and 60 minutes or less. In addition, after leaving, it may stand still for a certain period of time with the lid of the container open to remove the dyeing agent remaining in the sample. The leaving time at this time is not particularly limited, and is appropriately adjusted. The leaving time is, for example, 5 minutes or more and 30 minutes or less.

In addition, the thickness of the dyed first intermediate layer is an average value of the thicknesses of any 10 points obtained by measuring from the cross-section in the thickness direction of the layered body observed by the scanning transmission electron microscope (STEM).

### 4. Second Intermediate Layer

The second intermediate layer in the present embodiment is disposed between the first intermediate layer and the resin substrate, and contains a first component configuring the resin substrate.

The second intermediate layer contains a first component configuring the resin substrate. Further, when the resin substrate is configured by a plurality of components, the second intermediate layer may contain at least one component of the constituent components of the resin substrate. The first component is as described above.

When the content of the first component in the resin substrate is 100%, the ratio of the content of the first component in the second intermediate layer to the content of the first component in the resin substrate may be in the specified magnitude relationship of the ratio, and may be preferably 50% or more and 95% or less, more preferably 60% or more and 90% or less, and further more preferably 70% or more and 80% or less, for example. When the ratio is too small, the second intermediate layer cannot sufficiently absorb ultraviolet rays, and ultraviolet deterioration of the resin substrate may occur. In this case, the close adhesion between the resin substrate and the second intermediate layer may decrease. If the ratio is within the above range, since the second intermediate layer can sufficiently absorb ultraviolet rays, the close adhesion between the resin substrate and the second intermediate layer can be maintained.

The second intermediate layer preferably contains a second component constituting the optical resin layer. When the optical resin layer is composed of a plurality of components, the second intermediate layer preferably contains at least one component of the constituent components of the optical resin layer. The adhesion between the resin substrate and the optical resin layer can be improved. In addition, bending resistance can be improved. Note that the second component is as described above.

Since the relationship between the indentation hardness of the second intermediate layer and the indentation hardness of the resin substrate and the indentation hardness of the optical resin layer is the same as the relationship between the indentation hardness of the first intermediate layer and the indentation hardness of the resin substrate and the indentation hardness of the optical resin layer, detailed description thereof will be omitted.

When the indentation hardness of the optical resin layer is greater than the indentation hardness of the resin substrate, the indentation hardness of the second intermediate layer is preferably greater than the indentation hardness of the resin substrate and smaller than the indentation hardness of the optical resin layer, or the indentation hardness of the second intermediate layer is preferably smaller than each of the indentation hardness of the resin substrate and the indentation hardness of the optical resin layer. The hardness characteristics and the bending resistance of the layered body are improved. Above all, when the indentation hardness of the optical resin layer is greater than the indentation hardness of the resin substrate, the indentation hardness of the second intermediate layer is more preferably smaller than each of the indentation hardness of the resin substrate and the indentation hardness of the optical resin layer.

Further, the indentation hardness of the second intermediate layer is preferably smaller than each of the indentation hardness of the resin substrate and the indentation hardness of the optical resin layer. The bending resistance of the layered body is improved.

The indentation hardness of the second intermediate layer is preferably smaller than each of the indentation hardness of the resin substrate and the indentation hardness of the optical resin layer, and for example, preferably 100 MPa or more and 400 Pa or less, more preferably 200 MPa or more and 390 Pa or less, and further more preferably 300 MPa or more and 380 Pa or less. Since the indentation hardness of the second intermediate layer is within the above range, both the close adhesion between the resin substrate and the optical resin layer and the bending resistance of the layered body can be improved.

Above all, it is preferable that the relationship between the indentation hardness of the first intermediate layer and the indentation hardness of the resin substrate and the indentation hardness of the optical resin layer satisfies a preferable relationship, and the relationship between the indentation hardness of the second intermediate layer and the indentation hardness of the resin substrate and the indentation hardness of the optical resin layer satisfies a preferable relationship.

The method for measuring the indentation hardness of the second intermediate layer is the same as the method for measuring the indentation hardness of the first intermediate layer.

Here, in the measurement of the indentation hardness of the second intermediate layer, in order to avoid the influence of the resin substrate and the optical resin layer when the indenter is vertically pushed into the center of the cross-section of the second intermediate layer, the Berkovich indenter is pushed into the portion of the second intermediate layer separated from the interface between the second intermediate layer and the layer adjacent to the second intermediate layer to the center side of the second intermediate layer by 300 nm or more, and the center portion of the thickness of the second intermediate layer, and in order to avoid the influence of the side edge of the second intermediate layer, separated from the both edges of the second intermediate layer to the center side of the second intermediate layer by 500 nm or more.

Examples of the method for forming the second intermediate layer include a method of applying a second intermediate layer resin composition containing a first component and an arbitrary second component on the resin substrate.

The thickness of the second intermediate layer is not particularly limited if the close adhesion of the resin substrate and the optical resin layer is obtained, and for example, it is preferably 1 μm or more and 5 μm or less, more preferably 2 μm or more and 5 μm or less, and further more preferably 2 μm or more and 4 μm or less. If the thickness of the second intermediate layer is too thin, the close adhesion between the resin substrate and the optical resin layer may be insufficient. Further, when the thickness of the second intermediate layer is too thick, the thickness of the entire layered body increases, so that the bending resistance of the layered body tends to decrease.

Here, the method for measuring the thickness of the second intermediate layer is the same as the method for measuring the thickness of the first intermediate layer.

When the ratio of the content of the first component in each layer to the content of the first component in the resin substrate increases in the order of the first intermediate layer, the second intermediate layer, and the resin substrate, the first intermediate layer and the second intermediate layer have a low density of the first component configuring the resin substrate and become a low-density region. It is believed that at least one selected from the group consisting of ruthenium tetraoxide, osmium tetraoxide and tungsten phosphate adheres to the low-density region to selectively dye the first intermediate layer and the second intermediate layer.

At this time, since the content of the first component configuring the resin substrate differs between the first intermediate layer and the second intermediate layer, the density of the constituent components of the resin substrate is different. Therefore, it is considered that the dyeing concentration differs between the first intermediate layer and the second intermediate layer. Therefore, an interface between the first intermediate layer and the second intermediate layer can be observed.

Note that, when the first intermediate layer and the second intermediate layer are dyed by the dyeing agent, the interface between the first intermediate layer and the second intermediate layer may be unclear. Even in such a case, for example, as illustrated in FIG. 2, when the total thickness of the first intermediate layer 3 and the second intermediate layer 4 is regarded as T, in a case where the content of the first component configuring the resin substrate differs between the region of thickness T/3 from the optical resin layer 2 side and the region of thickness T/3 from the resin substrate 5 side the first intermediate layer and the third region, the layered body according to the present embodiment is considered to include a first intermediate layer and a second intermediate layer. Whether the content of the first component configuring the resin substrate differs between the region of thickness T/3 from the optical resin layer side and the region of thickness T/3 from the resin substrate side, can be confirmed by comparing the ratio of the content of the first component in each region with respect to the content of the first component in the resin substrate.

### 5. Other Layers

The layered body of the present embodiment can include other layers other than the resin substrate, the optical resin layer, the first intermediate layer, and the second intermediate layer.

### (1) Second Optical Resin Layer

The layered body of the present embodiment may include a second optical resin layer on a surface of the resin substrate that is opposite side to the optical resin layer. The second optical resin layer is the same as the optical resin layer.

### (2) Third Intermediate Layer and Fourth Intermediate Layer

In the present embodiment, the third intermediate layer, the fourth intermediate layer, and the second optical resin layer may be arranged in this order from the resin substrate side on the surface of the resin substrate that is opposite side to the optical resin layer. The third intermediate layer is the same as the second intermediate layer. The fourth intermediate layer is the same as the first intermediate layer. For example, when the layered body is disposed on the surface of the display device, the layered body is disposed such that the optical resin layer is on the observer side and the second optical resin layer is on the display panel side. In this case, deterioration of the resin substrate due to external light can be suppressed by the first intermediate layer and the second intermediate layer, and close adhesion between the resin substrate and the optical resin layer can be maintained. In addition, by the third intermediate layer and the fourth intermediate layer, deterioration of the resin substrate due to illumination light of the display device can be suppressed, and close adhesion between the resin substrate and the second optical resin layer can be maintained.

### (3) Adhesive Layer for Bonding

The layered body according to the present embodiment can include an adhesive layer for bonding on a surface of the resin substrate that is opposite side to the optical resin layer. The layered body can be bonded to, for example, a display panel or the like via the adhesive layer for bonding.

The adhesive used in the adhesive layer for bonding is not particularly limited as long as an adhesive has transparency and can bond the layered body to a display panel or the like, and examples thereof may include, a thermosetting adhesive, an ultraviolet-curable adhesive, a two-pack curable adhesive, a hot-melt adhesive, and a pressure-sensitive adhesive (so-called tackifier).

The thickness of the adhesive layer for bonding is, for example, preferably 10 μm or more and 100 μm or less, more preferably 25 μm or more and 80 μm or less, and further more preferably 40 μm or more and 60 μm or less. If the thickness of the adhesive layer for bonding is too thin, the layered body and the display panel or the like may not be sufficiently adhered. If the thickness of the adhesive layer for bonding is too thick, the flexibility may be impaired.

For example, an adhesive film may be used as the adhesive layer for bonding. In addition, for example, an adhesive composition may be applied onto the support or the resin substrate to form an adhesive layer for bonding.

### 6. Layered Body Characteristics

The total light transmittance of the layered body according to the present embodiment is preferably 85% or more, more preferably 88% or more, and more preferably 90% or more. Since the total light transmittance is high in this way, transparency is improved.

Here, the total light transmittance of the layered body is measured in accordance with JIS K 7361-1:1999. For example, a haze meter HM 150 from MURAKAMI COLOR RESEARCH LABORATORY CO., LTD. is used.

The haze of the layered body of the present embodiment is preferably, for example, 5% or less, more preferably 2% or less, and further more preferably 1% or less. Since the haze is low, transparency is improved.

Here, the haze of the layered body is measured according to JIS K 7136: 2000. For example, a haze meter H HM 150 from MURAKAMI COLOR RESEARCH LABORATORY CO., LTD. is used.

The layered body according to the present embodiment preferably has bending resistance. Specifically, when the dynamic bending test described below is performed to the layered body, it is preferable that the layered body does not crack, break, or peel.

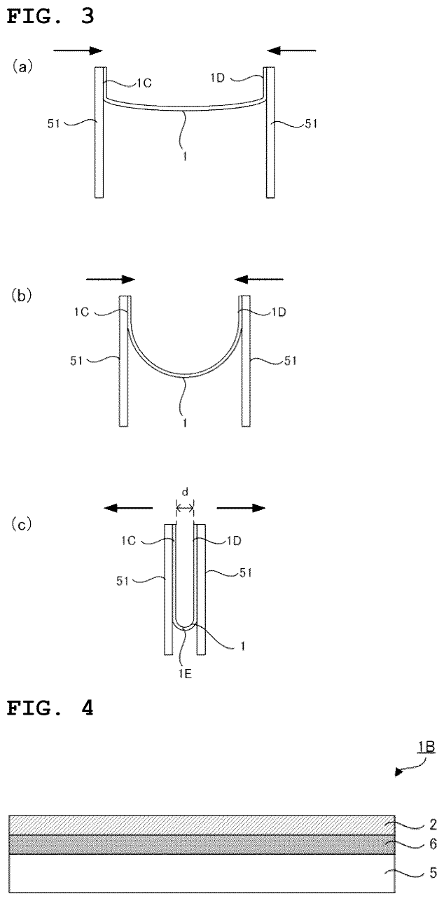

The dynamic bending test is performed as follows. First, a layered body having a size of 20 mm*100 mm is prepared. In the dynamic bending test, as illustrated in FIG. 3(a), the short side portion 1C of the layered body 1 and the short side portion 1D facing the short side portion 1C are respectively fixed by fixing portions 51 arranged in parallel. As shown in FIG. 3(a), the fixing portion 51 is slidable in the horizontal direction. Next, as illustrated in FIG. 3(b), by moving the fixing portions 51 so as to be close to each other, the layered body 1 is deformed to be folded, and as illustrated in FIG. 3(c), after the fixing portion 51 is moved to a position where the interval d between the two short side portions 1C and 1D fixed by the fixing portion 51 of the layered body 1 becomes a predetermined value, the fixing portion 51 is moved in the opposite direction to eliminate the deformation of the layered body 1. By moving the fixing portion 51 as shown in FIGS. 3(a) to 3(c), the layered body 1 can be folded by 180°. In addition, by performing a dynamic bending test so that the bent portion 1E of the layered body 1 does not protrude from the lower end of the fixing portion 51, and controlling the interval when the fixing portion 51 is closest to the fixing portion 51, the interval d between the two opposing short side portions 1C and 1D of the layered body 1 can be set to a predetermined value. For example, when the interval d between the short side portions 1C and 1D is 10 mm, the outer diameter of the bent portion 1E is considered to be 10 mm. For example, the dynamic bending test uses a durable testing machine (product name “DLDMLH-FS” from YUASA SYSTEM Co., Ltd.).

In the layered body, when the dynamic bending test for folding 180° so that the interval d between the opposing short side portions 1C and 1D of the layered body 1 is 10 mm is repeated 200,000 times, it is preferable that cracking, breaking or peeling does not occur. Above all, it is preferable that the cracking, breaking or peeling does not occur when the dynamic bending test for folding 180° so that the interval d between the opposing short side portions 1C and 1D of the layered body 1 is 8 mm is repeated 200,000 times.

In the dynamic bending test, the layered body may be folded such that the optical resin layer is outside, or the layered body may be folded such that the optical resin layer is inside, but it is preferable that the layered body is not cracked, broken, or peeled off in both cases.

Here, in the dynamic bending test, the “crack” refers to a phenomenon in which cracks occur in the layered body. Also, the “breaking” refers to a phenomenon in which the layered body is completely divided into two. In addition, the “peeling” refers to a phenomenon in which any layer configuring the layered body is peeled or floated.

In the present embodiment, deterioration of the resin substrate due to ultraviolet rays can be suppressed, and close adhesion between the resin substrate and the optical resin layer can be maintained. Specifically, when the layered body is subjected to an accelerated weathering test according to JIS K 5600-7-8: 1999, and then an adhesion test is performed by a cross-cut tape method according to JIS K 5400-8.5.2, the number of remaining squares among 100 mass is preferably 90 or more, more preferably 95 or more, and further more preferably 100.

### (Condition of Accelerated Weathering Test)

Operation: Method A, Exposure including steam condensation
UV lamp: Type 2 UVA (340)
Irradiation: Radiated illuminance of 0.63 W/m², temperature of 23±5° C., black panel temperature of 60±3° C., and irradiation time of 4 hours
Steam Condensation: Black panel temperature of 50±3° C., and water condensation time of 4 hours
One cycle: The irradiation and the water vapor condensation are sequentially performed to be one cycle.
Cycle number: 12 cycles

In the accelerated weathering test, the layered body is irradiated with ultraviolet rays from the optical resin layer side surface.

In addition, the adhesive test by the cross-cut tape method according to JIS K 5400-8.5.2 is performed by the following method. First, a cuter knife is used to form a grid of 100 squares by cutting a cut at an interval of 1 mm so as to reach the surface layer portion of the resin substrate from the optical resin layer side of the layered body. Next, a Cellophane tape (manufactured by NICHIBAN Co., Ltd.) is adhered on the grid, and then peeled off. This operation is repeated five times. Thereafter, the state of the grid is observed visually.

### 7. Other Points of Layered Body

The thickness of the layered body of the present embodiment is, for example, preferably 10 μm or more and 500 μm or less, more preferably 20 μm or more and 400 μm or less, and further more preferably 30 μm or more and 300 μm or less. If the thickness of the layered body is in the above range, the flexibility can be increased.

The layered body according to the present embodiment can be used as a front plate disposed closer to the observer side than the display panel in the display device. In addition, the layered body of the present embodiment can be used as a front plate disposed on the surface of the touch panel member. Above all, the layered body of the present embodiment can be suitably used for a front plate in a flexible display device such as a foldable display, a rollable display, a bendable display, or the like. In particular, since the layered body according to the present embodiment has good bending resistance, it can be suitably used for a front plate in a foldable display.

The layered body of the present embodiment can be used for, for example, a front plate in a display device such as a smartphone, a tablet terminal, a wearable terminal, a personal computer, a television, a digital signage, a public information display (PID), an on-vehicle display, or the like.

### II. SECOND EMBODIMENT

A second embodiment of the layered body according to the present disclosure includes an optical resin layer, an intermediate layer, and a resin substrate in this order, wherein the intermediate layer contains a first component configuring the resin substrate and a second component configuring the optical resin layer.

FIG. 4 is a schematic cross-sectional view illustrating an example of a layered body of the present embodiment. As shown in FIG. 4, the layered body 1B includes an optical resin layer 2, an intermediate layer 6, and a resin substrate 5 in this order. The intermediate layer 6 contains a first component configuring the resin substrate 5 and a second component configuring the optical resin layer 2.

In the present embodiment, since an intermediate layer containing a first component configuring the resin substrate and a second component configuring the optical resin layer is disposed between the optical resin layer and the resin substrate, close adhesion between the optical resin layer and the resin substrate can be improved.

Here, when the layered body is irradiated with ultraviolet rays from the optical resin layer side surface of the layered body, the resin substrate proceeds with deterioration from the optical resin layer side surface of the resin substrate. In the present embodiment, since the intermediate layer disposed between the optical resin layer and the resin substrate contains a first component constituting the resin substrate, even if the first component included in the intermediate layer deteriorates due to ultraviolet rays, it is possible to suppress deterioration of the resin substrate due to ultraviolet rays. Therefore, ultraviolet deterioration of the resin substrate can be suppressed, and adhesion between the optical resin layer and the resin substrate can be maintained.

As described above, in the present embodiment, it is possible to suppress a decrease in close adhesion between the optical resin layer and the resin substrate due to ultraviolet degradation of the resin substrate without using an ultraviolet absorber. Thus, since the optical resin layer contains an ultraviolet absorber, it is possible to suppress a decrease in the hardness characteristics of the optical resin layer as in the prior art. In addition, as in the prior art, it is possible to prevent the bending resistance from decreasing by unevenly distributing the ultraviolet absorber to the optical resin layer side surface of the resin substrate.

Hereinafter, each configuration of the layered body of the present embodiment will be described.

### 1. Resin Substrate

The material and thickness of the resin substrate are the same as the material and thickness of the resin substrate in the layered body of the first embodiment.

The indentation hardness of the resin substrate is preferably greater than the indentation hardness of the intermediate layer. The bending resistance of the layered body is improved.

The indentation hardness of the resin substrate is the same as the indentation hardness of the resin substrate in the layered body of the first embodiment.

### 2. Optical Resin Layer

The material, thickness, configuration, and formation method of the optical resin layer are the same as the material, thickness, configuration, and formation method of the optical resin layer in the layered body of the first embodiment.

The indentation hardness of the optical resin layer is preferably greater than the indentation hardness of the resin substrate. The hardness characteristics of the layered body are improved.

The indentation hardness of the optical resin layer is preferably greater than the indentation hardness of the intermediate layer. The hardness characteristics and the bending resistance of the layered body are improved.

The indentation hardness of the optical resin layer is the same as the indentation hardness of the optical resin layer in the layered body of the first embodiment.

### 3. Intermediate Layer

The intermediate layer in the present embodiment is disposed between the optical resin layer and the resin substrate, and contains a first component configuring the resin substrate, and a second component configuring the optical resin layer.

Each of the first component and the second component is the same as the first component and the second component in the layered body of the first embodiment.

The ratio of the content of the first component in each layer to the content of the first component in the resin substrate is preferably increased in the order of the optical resin layer, the intermediate layer, and the resin substrate. That is, the magnitude relationship of the ratio is preferably an optical resin layer<an intermediate layer<a resin substrate. The close adhesion between the resin substrate and the optical resin layer can be improved. Furthermore, the close adhesion between the resin substrate and the optical resin layer can be maintained even after exposure to ultraviolet rays.

When the content of the first component in the resin substrate is 100%, the ratio of the content of the first component in the intermediate layer to the content of the first component in the resin substrate may be in a predetermined magnitude relationship of the ratio, and for example, it is 10% or more and 90% or less, may be 15% or more and 60% or less, and may be 20% or more and 40% or less.

Since the relationship between the indentation hardness of the intermediate layer and the indentation hardness of the resin substrate and the indentation hardness of the optical resin layer is the same as the relationship between the indentation hardness of the first intermediate layer and the indentation hardness of the resin substrate and the indentation hardness of the optical resin layer in the layered body of the first embodiment, detailed description thereof will be omitted.

Further, the indentation hardness of the intermediate layer is preferably smaller than each of the indentation hardness of the resin substrate and the indentation hardness of the optical resin layer. The bending resistance of the layered body is improved.

The indentation hardness of the intermediate layer is the same as the indentation hardness of the first intermediate layer in the layered body of the first embodiment.

Examples of the method for forming the intermediate layer include a method of applying a resin composition for an intermediate layer containing a first component and an arbitrary second component on a resin substrate.

The thickness of the intermediate layer is the same as the thickness of the intermediate layer in the layered body of the first embodiment.

### 4. Other Layers

The layered body according to the present embodiment can include other layers other than the resin substrate, the optical resin layer, and the intermediate layer.

### (1) Second Optical Resin Layer

The layered body of the present embodiment may include a second optical resin layer on a surface of the resin substrate that is opposite side to the optical resin layer. The second optical resin layer is the same as the optical resin layer.

### (2) Fifth Intermediate Layer

The layered body of the present embodiment may include a fifth intermediate layer between the resin substrate and the second optical resin layer. The fifth intermediate layer is the same as the intermediate layer. For example, when the layered body is disposed on the surface of the display device, the layered body is disposed such that the optical resin layer is on the observer side and the second optical resin layer is on the display panel side. In this case, deterioration of the resin substrate due to external light can be suppressed by the intermediate layer, and close adhesion between the resin substrate and the optical resin layer can be maintained. In addition, the fifth intermediate layer suppresses deterioration of the resin substrate due to the illumination light of the display device, and can maintain close adhesion between the resin substrate and the second optical resin layer.

### (3) Adhesive Layer for Bonding

The layered body according to the present embodiment can include an adhesive layer for bonding on a surface of the resin substrate that is opposite side to the optical resin layer. The adhesive layer for bonding is the same as the adhesive layer for bonding in the layered body of the first embodiment.

### 5. Characteristics of the Layered Body

The characteristics of the layered body of the present embodiment are the same as those of the layered body of the first embodiment.

### 6. Other Points of the Layered Body

The thickness and applications of the layered body according to the present embodiment are the same as the thickness and applications of the layered body according to the first embodiment.

### III. THIRD EMBODIMENT

A third embodiment of a layered body according to the present disclosure is a layered body including an optical resin layer, an intermediate layer, and a resin substrate in this order, wherein the intermediate layer contains a first component configuring the resin substrate, and when the layered body is subjected to an accelerated weathering test according to JIS K 5600-7-8: 1999 described below, and then an adhesive test is performed by a cross-cut tape method according to JIS K 5400-8.5.2, the number of remaining squares among the 100 squares is 90 or more.

### (Condition of Accelerated Weathering Test)

Operation: Method A, Exposure including steam condensation
UV lamp: Type 2 UVA (340)
Irradiation: Radiated illuminance of 0.63 W/m², temperature of 23±5° C., black panel temperature of 60±3° C., and irradiation time of 4 hours
Steam Condensation: Black panel temperature of 50±3° C., and water condensation time of 4 hours
One cycle: The irradiation and the water vapor condensation are sequentially performed to be one cycle.
Cycle number: 12 cycles

FIG. 4 is a schematic cross-sectional view illustrating an example of a layered body of the present embodiment. As shown in FIG. 4, the layered body 1B includes an optical resin layer 2, an intermediate layer 6, and a resin substrate 5 in this order. The intermediate layer 6 contains a first component configuring the resin substrate 5. In addition, in the layered body 1B, when the above-described accelerated weathering test is performed, and then the adhesive test is performed by the cross-cut tape method described above, the number of remaining squares among 100 squares is equal to or greater than a predetermined value.

In the present embodiment, since an intermediate layer containing a first component configuring the resin substrate is disposed between the optical resin layer and the resin substrate, close adhesion between the optical resin layer and the resin substrate can be improved.

Here, when the layered body is irradiated with ultraviolet rays from the optical resin layer side surface of the layered body, the resin substrate proceeds with deterioration from the optical resin layer side surface of the resin substrate. In the present embodiment, since the intermediate layer disposed between the optical resin layer and the resin substrate contains a first component configuring the resin substrate, even if the first component included in the intermediate layer deteriorates due to ultraviolet rays, it is possible to suppress deterioration of the resin substrate due to ultraviolet rays. In addition, in the layered body of the present embodiment, when the accelerated weathering test is performed, and then the adhesion test is performed by the cross-cut tape method described above, the number of remaining squares among 100 masses is equal to or greater than a predetermined value and thus, the close adhesion after the accelerated weathering test is excellent. Therefore, ultraviolet deterioration of the resin substrate can be suppressed, and close adhesion between the optical resin layer and the resin substrate can be maintained high.

As described above, in the present embodiment, it is possible to suppress a close decrease in adhesion between the optical resin layer and the resin substrate due to ultraviolet degradation of the resin substrate without using an ultraviolet absorber. Thus, since the optical resin layer contains an ultraviolet absorber as in the prior art, it is possible to suppress a decrease in the hardness characteristics of the optical resin layer. In addition, as in the prior art, it is possible to prevent the bending resistance from decreasing by unevenly distributing the ultraviolet absorber to the optical resin layer side surface of the resin substrate.

Hereinafter, each configuration of the layered body of the present embodiment will be described.

### 1. Resin Substrate

The material and thickness of the resin substrate are the same as the material and thickness of the resin substrate in the layered body of the first embodiment.

The indentation hardness of the resin substrate is preferably greater than the indentation hardness of the intermediate layer. The bending resistance of the layered body is improved.

The indentation hardness of the resin substrate is the same as the indentation hardness of the resin substrate in the layered body of the first embodiment.

### 2. Optical Resin Layer

The material, thickness, configuration, and formation method of the optical resin layer are the same as the material, thickness, configuration, and formation method of the optical resin layer in the layered body of the first embodiment.

The indentation hardness of the optical resin layer is preferably greater than the indentation hardness of the resin substrate. The hardness characteristics of the layered body are improved.

The indentation hardness of the optical resin layer is preferably greater than the indentation hardness of the intermediate layer. The hardness characteristics and the bending resistance of the layered body are improved.

The indentation hardness of the optical resin layer is the same as the indentation hardness of the optical resin layer in the layered body of the first embodiment.

### 3. Intermediate Layer

The intermediate layer in the present embodiment is disposed between the optical resin layer and the resin substrate, and contains a first component configuring the resin substrate.

The first component is the same as the first component in the layered body of the first embodiment.

The ratio of the content of the first component in each layer to the content of the first component in the resin substrate is preferably increased in the order of the optical resin layer, the intermediate layer, and the resin substrate. That is, the magnitude relationship of the ratio is preferably an optical resin layer<an intermediate layer<a resin substrate. The close adhesion between the resin substrate and the optical resin layer can be improved. Furthermore, the close adhesion between the resin substrate and the optical resin layer can be maintained even after exposure to ultraviolet rays.

When the content of the first component in the resin substrate is 100%, the ratio of the content of the first component in the intermediate layer to the content of the first component in the resin substrate is the same as the ratio of the content of the first component in the intermediate layer to the content of the first component in the resin substrate in the layered body of the second embodiment.

The intermediate layer preferably contains a second component configuring the optical resin layer. When the optical resin layer is configured by a plurality of components, the intermediate layer preferably contains at least one component of the constituent components of the optical resin layer. The close adhesion between the resin substrate and the optical resin layer can be improved. When the optical resin layer is multilayer, the second component configuring the optical resin layer is a constituent component of a layer adjacent to the intermediate layer among the layers configuring the optical resin layer.

The second component is the same as the second component in the layered body of the first embodiment.

Since the relationship between the indentation hardness of the intermediate layer and the indentation hardness of the resin substrate and the indentation hardness of the optical resin layer is the same as the relationship between the indentation hardness of the first intermediate layer and the indentation hardness of the resin substrate and the indentation hardness of the optical resin layer in the layered body of the first embodiment, detailed description thereof will be omitted.

Further, the indentation hardness of the intermediate layer is preferably smaller than each of the indentation hardness of the resin substrate and the indentation hardness of the optical resin layer. The bending resistance of the layered body is improved.

The indentation hardness of the intermediate layer is the same as the indentation hardness of the first intermediate layer in the layered body of the first embodiment.

Examples of the method for forming the intermediate layer include a method of applying a resin composition for intermediate layer containing a first component and an arbitrary second component on a resin substrate.

The thickness of the intermediate layer is the same as the thickness of the intermediate layer in the layered body of the first embodiment.

### 4. Other Layers

The layered body of the present embodiment can include other layers other than the resin substrate, the optical resin layer, and the intermediate layer. Examples of other layers include a second optical resin layer, a fifth intermediate layer, and an adhesive layer for bonding. The second optical resin layer, the fifth intermediate layer, and the adhesive layer for bonding are respectively the same as the second optical resin layer, the fifth intermediate layer, and the adhesive layer for bonding in the layered body of the second embodiment.

### 5. Characteristics of the Layered Body

The characteristics of the layered body of the present embodiment are the same as those of the layered body of the first embodiment.

### 6. Other Points of the Layered Body

The thickness and applications of the layered body according to the present embodiment are the same as the thickness and applications of the layered body according to the first embodiment.

### B. Touch Panel Member

The touch panel member according to the present disclosure includes the above described layered body on its surface.

In the touch panel member including a layered body on the surface, the layered body is disposed such that the resin substrate is on the touch panel member side and the optical resin layer is on the user side.

Examples of the method for disposing the layered body on the surface of the touch panel member include, for example, a method for bonding the layered body to the touch panel member via the adhesive layer, but not particularly limited thereto. In addition, the resin substrate configuring the layered body may also serve as a substrate layer configuring the touch panel member. In this case, an electrode constituting the touch panel member may be formed on the resin substrate side surface of the layered body.

Examples of the touch panel member include, for example, an electrostatic capacitance type, a resistive film type, an optical type, an ultrasonic type, and an electromagnetic induction type, but not particularly limited thereto.

### C. Display Device

A display device according to the present disclosure includes a display panel and the above described layered body disposed on the observer side of the display panel.

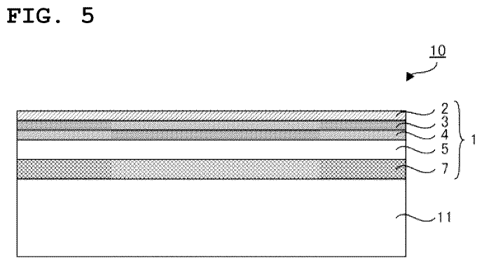

FIG. 5 is a schematic cross-sectional view showing an example of a display device according to the present disclosure. As shown in FIG. 5, the display device 10 includes a display panel 11 and a layered body 1 disposed on an observer side of the display panel 11. In the display device 10, the layered body 1 and the display panel 11 can be bonded, for example, via the adhesive layer 7 for bonding of the layered body 1.

When the layered body is disposed on the surface of the display panel, as illustrated in FIG. 5, the layered body 1 is disposed such that the resin substrate 5 is on the display panel 11 side and the optical resin layer 2 is on the observer side.

Examples of the method for disposing the layered body on the surface of the display panel include, for example, a method for bonding the layered body to the display panel via the adhesive layer, but not particularly limited thereto.

Examples of the display panel include a display panel used in a display device such as an organic EL display device and a liquid crystal display device.

The display device may include a touch panel member between the display panel and the layered body.

The display device according to the present disclosure is preferably a flexible display device such as a foldable display, a rollable display, a bendable display, or the like.

In addition, the display device according to the present disclosure is preferably foldable. That is, the display device according to the present disclosure is preferably a foldable display. The display device according to the present disclosure has good bending resistance and is suitable as a foldable display.

The present disclosure is not limited to the above-described embodiments. The above described embodiments are illustrative and anything that has substantially the same configuration as the technical idea described in the claims of the present disclosure, and has a similar effect is encompassed in the technical scope of the present disclosure.

### EXAMPLES

Hereinafter, the present disclosure will be described further with reference to examples and comparative examples.

### Example 1

### (1) Production of a Resin Substrate

### (1-1) Synthesis of Polyimide

The polyamic acid solution was obtained by nitrogen-substituting 500 mL of separable controlling the dehydrated dimethylacetamide (DMAc) 398.58 g and 2,2′-bis (trifluoromethyl)benzidine (TFMB) 36.65 g (114.4 mmol) was dissolved so that the solution temperature became 30° C., and then adding the 4,4′-(hexafluoroisopropylidene)diphthalic anhydride (6 DA) 50.54 g (113.8 mmol) gradually thereto and stirring at a temperature rise of 2° C. or lower for 3 hours by a mechanical stirrer. Next, pyridine 1.73 g (79.1 mmol) and acetic anhydride 55.85 g (547.1 mmol), which are catalysts, were charged and further stirred for 3 hours to obtain a polyimide solution. Thereafter, 2-propyl alcohol (IPA) 233.65 g was gradually added to the solution cooled to room temperature to obtain a slightly turbid solution. A white slurry was obtained by adding IPA 467.5 g to a solution in which turbidity was found. The slurry was filtered and washed 5 times with IPA, and then dried for 6 hours while reducing the pressure in an oven heated to 100° C., whereby 66.1 g of the polyimide powder A was obtained.

### (1-2) Production of a Polyimide Film

A polyimide resin composition 1 having a solid content of 12% was prepared by adding N, N-dimethylacetamide (DMAc) to the polyimide powder A. A single layer polyimide film having a thickness of 77.5 μm was produced by using the polyimide resin composition 1 and performing the following procedures (1) to (2). (1) The polyimide resin composition 1 was applied on a glass plate, dried in a circulation oven at 120° C. for 10 minutes, then cooled to 25° C., and the polyimide resin coating film was peeled off. (2) The peeled polyimide resin coating film was cut into a size of 150 mm*200 mm.

Two metal frames (external dimensions of 150 mm*200 mm, internal dimensions of 130 mm*180 mm) are used to hold the cut polyimide resin coating film, and the metal frames and the polyimide resin coating film were fixed by the fixing jig. The fixed polyimide resin coating film is heated at a temperature rising speed of 10° C./minute in a nitrogen gas flow-down (oxygen concentration of 100 ppm or less) in a circulation oven and heated to 300° C., held at 300° C. for 1 hour, cooled to 25° C., and a single-layer polyimide film was produced.

### (2) Forming of the Second Intermediate Layer

The resin composition for the second intermediate layer was prepared by blending each component so as to have the composition described below.

### <Composition of Resin Composition for Second Intermediate Layer>

Mixture of dipentaerythritol pentaacrylate and dipentaerythritol hexaacrylate (M403, manufactured by TOAGOSEI CO., LTD.) 4.8 parts by mass
Dipentaerythritol EO-modified hexaacrylate (A-DPH-6E, manufactured by SHIN-NAKAMURA CHEMICAL CO, LTD.) 4.8 parts by mass
The polyimide 40.5 parts by mass
Photopolymerization initiator (Irg184) 4 parts by mass
Fluorine-based leveling agent (F568 manufactured by DIC CORPORATION) 0.05 parts by mass
Solvent (MIBK) 150 parts by mass

The resin composition for the second intermediate layer was applied on the resin substrate, and after drying at 70° C. for 1 minute, the ultraviolet light was irradiated with an exposure amount of 200 mJ/cm² nitrogen flow-down, so as to cure and form the second intermediate layer having a thickness of about 2.5 μm.

### (3) Forming of the First Intermediate Layer

The resin composition for the first intermediate layer was prepared by blending each component so as to be the composition described below.

### <Composition of Resin Composition for First Intermediate Layer>

A mixture of dipentaerythritol pentaacrylate and dipentaerythritol hexaacrylate (M403, manufactured by TOAGOSEI CO., LTD.) 18.2 parts by mass
Dipentaerythritol EO-modified hexaacrylate (A-DPH-6E, manufactured by SHIN-NAKAMURA CHEMICAL CO, LTD.) 18.2 parts by mass
The polyimide 13.5 parts by mass
Photopolymerization initiator (Irg184) 4 parts by mass
Fluorine-based leveling agent F568 (manufactured by DIC CORPORATION) 0.05 parts by mass
Solvent (MIBK) 150 parts by mass

The resin composition for the first intermediate layer was applied on the second intermediate layer, and after drying at 70° C. for 1 minute, the ultraviolet light was irradiated with an exposure amount of 200 mJ/cm² nitrogen flow-down, so as to cure and form the first intermediate layer having a thickness of about 2.6 μm.

### (4) Formation of an Optical Resin Layer

The resin composition for the optical resin layer was prepared by blending each component so as to have the following composition.

### <Composition of Resin Composition for Optical Resin Layer>

A mixture of dipentaerythritol pentaacrylate and dipentaerythritol hexaacrylate (M403, manufactured by TOAGOSEI CO., LTD.) 25 parts by mass
Dipentaerythritol EO-modified hexaacrylate (A-DPH-6E, manufactured by SHIN-NAKAMURA CHEMICAL CO, LTD.) 25 parts by mass
Photopolymerization initiator (Irg184) 4 parts by mass
Fluorine-based leveling agents (F568 manufactured by DIC CORPORATION) 0.2 parts by mass
Solvent (MIBK) 150 parts by mass

A resin composition for an optical resin layer was applied on the first intermediate layer, and after drying at 70° C. for one minute, the ultraviolet light was irradiated with an exposure amount of 400 mJ/cm² nitrogen flow-down, so as to cure and form the optical resin layer having a thickness of about 2.5 μm. As a result, the layered body was obtained.

### Examples 2-4, 6-16

A layered body was produced in the same manner as in Example 1 except that the compositions of the resin composition for the optical resin layer, the resin composition for the first intermediate layer, and the resin composition for the second intermediate layer, and the thicknesses of the optical resin layer, the first intermediate layer, the second intermediate layer, and the resin substrate were changed as shown in Table 1. For the composition of each resin composition, the ratio of the content of the polyimide component to the solid content other than the solvent was prepared so as to be the ratio shown in Table 1.

### Example 5

A layered body was produced in the same manner as in Example 1 except that a resin composition for an optical resin layer of the following composition was prepared, and the thicknesses of the optical resin layer, the first intermediate layer, and the second intermediate layer were changed as shown in Table 1.

### <Composition of Resin Composition for Optical Resin Layer>

A mixture of dipentaerythritol pentaacrylate and dipentaerythritol hexaacrylate (M403 manufactured by TOAGOSEI CO., LTD.) 25 parts by mass
of dipentaerythritol EO-modified hexaacrylate (A-DPH-6E manufactured by SHIN-NAKAMURA CHEMICAL CO, LTD.) 25 parts by mass
Anisotropic silica fine particles (an average particle size of 25 nm manufactured by JGC Catalysts and Chemicals Ltd.) 50 parts by mass
Photopolymerization initiator (Irg184) 4 parts by mass
Fluorine-based leveling agent (F568 manufactured by DIC CORPORATION) 0.2 parts by mass
Solvent (MIBK) 300 parts by mass

### Examples 17 to 19

A layered body was produced in the same manner as in Example 1 except that the second intermediate layer was not formed, and compositions of the resin composition for the optical resin layer and the resin composition for the intermediate layer, and the thicknesses of the optical resin layer, the intermediate layer, and the resin substrate were changed as shown in Table 1. For the composition of each resin composition, the ratio of the content of the polyimide component to the solid content other than the solvent was prepared so as to be the ratio shown in Table 1. The components included in the resin composition for the intermediate layer were the same as those included in the resin composition for the first intermediate layer of Example 1.

### Comparative Example 1

The layered body was produced in the same manner as in Example 1 except that the first intermediate layer and the second intermediate layer were not formed and the thicknesses of the resin substrate and the optical resin layer were changed as shown in Table 1.

### Comparative Example 2

A layered body was obtained in the same manner as in Comparative Example 1 except that the UV absorber (DAINSORB P6 manufactured by Daiwa Fine Chemicals Co., Ltd.) was added to the resin composition for the optical resin layer used in Example 1 such that the content of the ultraviolet absorber with respect to the solid content was 8 mass %.

### Comparative Example 3

First, in the same manner as in Example 1, a single-layer polyimide film having a thickness of 80.1 μm was produced.

The polyimide resin composition 2 having a solid content of 12% including 11.64 parts by mass of the polyimide powder A, 0.36 parts by mass of an ultraviolet absorber (DAINSORB P6, manufactured by Daiwa Fine Chemicals Co., Ltd.), and 80 parts by mass of N, N-dimethylacetamide (DMAc) was prepared. The polyimide resin composition 2 was applied on the polyimide film, dried in a circulation oven at 120° C. for 10 minutes, and then cooled to 25° C. The polyimide resin coating film was heated at a temperature rising speed of 10° C./minute in a nitrogen gas flow-down (oxygen concentration of 100 ppm or less) in a circulation oven to 300° C., held at 300° C. for 1 hour, cooled to 25° C., and a polyimide layer having a thickness of 5.0 μm was formed. As a result, a layered body including a polyimide film and a polyimide layer was obtained.

### Examples 20, 23

A layered body was produced in the same manner as in Example except that the components included in the resin composition for the optical resin layer were the same as the components included in the resin composition for the optical resin layer of Example 5, and the compositions of the resin composition for the optical resin layer, the resin composition for the first intermediate layer, and the resin composition for the second intermediate layer, and the thicknesses of the optical resin layer, the first intermediate layer, the second intermediate layer, and the resin substrate were changed as shown in Table 1. The composition of each resin composition was prepared such that the contents of a mixture of dipentaerythritol pentaacrylate and dipentaerythritol hexaacrylate (M403 manufactured by TOAGOSEI CO., LTD.), dipentaerythritol EO-modified hexaacrylate (A-DPH-6E, manufactured by SHIN-NAKAMURA CHEMICAL CO, LTD.), anisotropic silica fine particles (an average particle size of 25 nm manufactured by JGC Catalysts and Chemicals Ltd.) and the ratio of the content of the polyimide component to solid content other than the solvent, were the ratio shown in Table 1.

### Example 21, 22

First, the polyimide resin composition 2 described below was prepared, and a single-layer polyimide film was produced in the same manner as in Example 1. The polyimide resin composition 2 was prepared by adding an acrylic resin (EBECRYL 767: manufactured by Daicel Corporation) to the polyimide resin composition 1 used in Example 1 such that the content of the acrylic resin relative to the solid content was 1.5 mass %. Next, a layered body was produced in the same manner as in Example 1 except that the components included in the resin composition for the optical resin layer were the same as those included in the resin composition for the optical resin layer of Example 5, and the composition of the resin composition for the optical resin layer, the resin composition for the first intermediate layer, and the resin composition for the second intermediate layer, and the thickness of the optical resin layer, the first intermediate layer, the second intermediate layer, and the resin substrate were changed as shown in Table 1. The composition of each resin composition was prepared such that the contents of a mixture of dipentaerythritol pentaacrylate and dipentaerythritol hexaacrylate (M403 manufactured by TOAGOSEI CO., LTD.), dipentaerythritol EO-modified hexaacrylate (A-DPH-6E, manufactured by SHIN-NAKAMURA CHEMICAL CO, LTD.), anisotropic silica fine particles (an average particle size of 25 nm manufactured by JGC Catalysts and Chemicals Ltd.) and the ratio of the content of the polyimide component to solid content other than the solvent, were the ratio shown in Table 1.

### Comparative Example 4

A layered body was produced in the same manner as in Example 1 except that the resin composition for the optical resin layer described below was prepared, and the thicknesses of the optical resin layer, the first intermediate layer, the second intermediate layer, and the resin substrate were changed as shown in Table 1.

The resin composition for an optical resin layer was prepared by adding an ultraviolet absorber (DAINSORB P6 manufactured by Daiwa Fine Chemicals Co., Ltd.) such that the content of the ultraviolet absorber with respect to the solid content was 8 mass %, to the resin composition for the optical resin layer used in Example 1.

### Comparative Example 5

The resin composition for the optical resin layer described below was prepared, and a layered body was produced in the same manner as in Example 17 except that the thicknesses of the optical resin layer, the intermediate layer, and the resin substrate were changed as shown in Table 2.

The resin composition for an optical resin layer was prepared by adding an ultraviolet absorber (DAINSORB P6 manufactured by Daiwa Fine Chemicals Co., Ltd.) such that the content of the ultraviolet absorber with respect to the solid content was 8 mass %, to the resin composition for the optical resin layer used in Example 1.

### [Evaluation]

### (1) Indentation Hardness

The indentation hardness of each layer was measured using “Hysitron TI950 TriboIndenter” manufactured by BRUKER. Specifically, first, a block in which a resin layer cut out at 1 mm*10 mm was embedded by embedding resin was produced. Next, using ultra-microtome (“Ultra Microtome EM UC7” manufactured by Leica Microsystems) was used to cut a section having a uniform thickness of 50 nm or more and 100 nm or less without a hole or the like from the block. Then, the remaining block from which the section was cut out was used as a measurement sample. Next, a Berkovich indenter (triangular pyramid, “TI-0039” manufactured by BRUKER) was used, and in the cross-section obtained by cutting out the section in the measurement sample, the indenter was pushed vertically into the center of the cross-section of the layer to be measured under the following measurement conditions. Here, the Berkovitch indenter was pushed into the center portion of the thickness of the measurement target layer distanced from the interface between the measurement target layer and the layer adjacent to the measurement target layer by 300 nm or more. The case of Example 1 will be described. When measuring the indentation hardness of the optical resin layer, the indenter was pushed into a position 1.23 μm away in the thickness direction from the interface between the optical resin layer and the first intermediate layer. Further, when measuring the indentation hardness of the first intermediate layer, the indenter was pushed into a position 1.3 μm away in the thickness direction from the interface between the optical resin layer and the first intermediate layer, and 1.3 μm away in the thickness direction from the interface between the first intermediate layer and the second intermediate layer. Further, when measuring the indentation hardness of the second intermediate layer, the indenter was pushed into a position 1.25 μm away in the thickness direction from the interface between the first intermediate layer and the second intermediate layer, and 1.25 μm away in the thickness direction from the interface between the second intermediate layer and the resin substrate. Further, when measuring the indentation hardness of the resin substrate, the indenter was pushed into a position 38.7 μm away in the thickness direction from the interface between the resin substrate and the second intermediate layer. Thereafter, after holding a constant level and relaxing the residual stress, the load was removed and the maximum load after relaxation was measured. And the maximum load Pₘₐₓ and contact projection area Aₚ were used and the indentation hardness (H_{IT}) was calculated by Pₘₐₓ/Aₚ. The contact projection area was the contact projection area obtained by correcting the indenter tip curvature by the Oliver-Pharr method using a standard sample of molten quartz (“5-0098” manufactured by BRUKER). Indentation hardness (H_{IT}) was measured at 10 points for each layer, and the arithmetic average value of a total of 10 measurement values was used. In addition, when the measured value contained a value that is out of ±20% or more from the arithmetic average value, the measured value was excluded and re-measurement was performed.

### (Measurement Condition)

Push-in control system: Displacement control system
Indentation depth: 100 nm
Push-in speed: 10 nm/seconds
Load time: 20 seconds
Retention time: 5 seconds
Load unloading speed: 10 nm/seconds
Load removal time: 20 seconds
Measurement temperature: 25° C.

### (2) The Content of the First Component Configuring The Resin Substrate

The ratio of the content of the first component in each layer to the content of the first component in the resin substrate was obtained by measuring the cross-section of the layered body by the AFM-IR method. The AFM-IR measurement was performed under the following conditions using nanoIR from Anays Instruments company.
Light source: Tunable Pulsed Laser (1 kHz)
AFM mode: contact mode (AFM-IR spectrum acquisition)
Measurement wave number range: 1950 cm⁻¹ to 950 cm⁻¹
Wave number resolution: 1.5 cm⁻¹
Coverages: 512
Integrated number of times: three or more times
Polarization angle: 45 degrees

When the IR spectrum of the resin substrate was confirmed, the peak derived from C═O stretching vibration at 1721 cm⁻¹ and the peak derived from C—N stretching vibration at 1363 cm⁻¹ were confirmed. Since the peaks seen in other polyester-based resins and polyamide-based resins were not be confirmed, it was confirmed that the resin substrate was a single polyimide-based resin. In the IR spectrum of the resin substrate, the intensity of the peak of 1363 cm⁻¹ was set to 1, the ratio of the intensity of each peak of the first intermediate layer, the second intermediate layer, and the optical resin layer was obtained, and the ratio of the content of the first component in each layer was calculated. Here, in the IR spectrum, since the peak derived from the C═O stretching vibration of the polyimide-based resin configuring the resin substrate and the peak derived from the C═O stretching vibration of the acrylic resin configuring the first intermediate layer, the second intermediate layer, and the optical resin layer were close to each other, the ratio of the intensity of the peak derived from the C—N stretching vibration was obtained.

### (3) Close Adhesiveness

First, an accelerated weathering test conforming to JIS K 5600-7-8: 1999 below was performed to the layered body.

### (Condition of Accelerated Weathering Test)

Operation: Method A, Exposure including steam condensation
UV lamp: Type 2 UVA (340)
Irradiation: Radiated illuminance of 0.63 W/m², temperature of 23±5° C., black panel temperature of 60±3° C., and irradiation time of 4 hours
Steam Condensation: Black panel temperature of 50±3° C., and water condensation time of 4 hours
One cycle: The irradiation and the water vapor condensation are sequentially performed to be one cycle.
Cycle number: 12 cycles

Next, after the accelerated weathering test, the adhesion test was performed by the cross-cut tape method based on JIS K 5400-8.5.2: 1990. First, a cuter knife was used to form a 100-square grid by cutting a cut at a 1 mm interval so as to reach the surface layer portion of the resin substrate from the optical resin layer side of the layered body. Next, a Cellophane tape (manufactured by NICHIBAN Co., Ltd.) was adhered on the grid, and then peeled off. This operation was repeated five times. Thereafter, the state of the grid was observed visually.

The result of the adhesion test was evaluated on the basis of the following criteria.
A: The number of remaining squares among 100 squares was 100.
B: The number of remaining squares among 100 squares was 90 or more and 99 or less.
C: The number of remaining squares among 100 squares was 89 or less.

### (4) Bending Resistance

The following dynamic bending test was performed on the layered body, and the bending resistance was evaluated. First, a layered body having a size of 20 mm*100 mm was prepared, and as shown in FIG. 3(a), the short side portion 1C of the layered body 1 and the short side portion 1D facing the short side portion 1C are fixed to the endurance test machine (product name “DLDMLH-FS” from YUASA SYSTEM Co., Ltd.) by fixing portions 51 arranged in parallel. Next, as shown in FIG. 3(b), by moving the fixing portions 51 so as to approach each other, the layered body 1 was deformed to be folded, and further, as shown in FIG. 3(c), after the fixing portions 51 were moved to positions where the interval d between the two facing short side portions 1C and 1D fixed by the fixing portions 51 of the layered body 1 became a predetermined value, the fixing portions 51 were moved in the reverse direction to eliminate the deformation of the layered body 1. By moving the fixing portions 51 as shown in FIGS. 3(a) to 3(c), the operation of folding the layered body 1 180° was repeatedly performed 200,000 times. At this time, the interval d between the two facing short side portions 1C and 1D of the layered body 1 was set to 4 mm, 6 mm, 8 mm, and 10 mm. In addition, the layered body is bent such that the resin substrate was outside and the optical resin layer was inside. The result of the dynamic bending test was evaluated on the basis of the following criteria.
A: In all the cases where the interval d was 4 mm, 6 mm, 8 mm, and 10 mm, cracking, breaking and peeling did not occur in the layered body.
B: When the interval d was 6 mm, 8 mm, and 10 mm, cracking, breaking, and peeling did not occur in the layered body.
C: When the interval d was 8 mm and 10 mm, cracking, breaking, and peeling did not occur in the layered body.
D: When the interval d was 10 mm, cracking, breaking and peeling did not occur in the layered body.

### (5) Steel Wool Resistance

By using #0000 steel wool (“BON STAR” manufactured by NIHON STEEL WOOL Co., Ltd.), reciprocating friction was performed on the optical resin layer side surface of the layered body of Examples at the speed of 50 mm/second while the load of 1 kg/cm² was applied, 3500 times. Thereafter, the presence or absence of scratches on the surface of the layered body was visually confirmed and evaluated based on the following criteria.
A: Not scratched
B: Scratched

### (6) Pencil Hardness

For the layered body of Examples, the pencil hardness on the optical resin layer side surface of the layered body was measured in accordance with JIS K 5600-5-4: 1999. At this time, as the pencil hardness testing machine, a “pencial scratch coating film hardness tester (electric motor)” manufactured by Toyo Seiki Seisaku-sho, Ltd. was used. The measurement conditions were an angle of 45°, a load of 1 kg, a speed of 0.5 mm/second or more and 1 mm/second or less, and a temperature of 23±2° C.

TABLE 1

| | | | | | | | | Indentation | | | |
|---|---|---|---|---|---|---|---|---|---|---|---|
| | Thickness (μm) | | | | | | | hardness (MPa)*² | | | |
| | | Optical | 1st | 2nd | | UV absorber | | Optical | 1st | 2nd | |
| | | resin | intermediate | intermediate | Resin | containing | content | resin | intermediate | intermediate | Resin |
| | Whole | layer | layer | layer | substrate | layer | (mass %) | layer | layer | layer | substrate |
| Ex. 1 | 85.1 | 2.5 | 2.6 | 2.5 | 77.5 | None | 0 | 434 | 327 | 373 | 408 |
| Ex. 2 | 85.0 | 2.5 | 2.5 | 2.5 | 77.5 | None | 0 | 415 | 340 | 348 | 403 |
| Ex. 3 | 84.8 | 2.4 | 2.5 | 2.5 | 77.4 | None | 0 | 439 | 355 | 388 | 413 |
| Ex. 4 | 85.0 | 2.4 | 2.5 | 2.5 | 77.6 | None | 0 | 436 | 290 | 281 | 411 |
| Ex. 5 | 84.7 | 2.3 | 2.6 | 2.3 | 77.5 | None | 0 | 608 | 330 | 363 | 405 |
| Ex. 6 | 85.2 | 2.5 | 2.7 | 2.5 | 77.5 | None | 0 | 370 | 317 | 313 | 408 |
| Ex. 7 | 85.0 | 2.4 | 2.4 | 2.3 | 77.9 | None | 0 | 426 | 363 | 396 | 411 |
| Ex. 8 | 85.3 | 2.6 | 2.4 | 2.5 | 77.8 | None | 0 | 422 | 279 | 238 | 410 |
| Ex. 9 | 85.3 | 4.0 | 1.1 | 1.0 | 79.3 | None | 0 | 433 | 341 | 373 | 407 |
| Ex. 10 | 84.8 | 2.4 | 1.4 | 1.5 | 79.5 | None | 0 | 431 | 333 | 371 | 411 |
| Ex. 11 | 85.1 | 2.6 | 1.8 | 1.7 | 79.0 | None | 0 | 435 | 338 | 379 | 410 |
| Ex. 12 | 85.4 | 2.6 | 2.0 | 2.1 | 78.7 | None | 0 | 436 | 338 | 381 | 409 |
| Ex. 13 | 84.9 | 2.4 | 1.8 | 1.8 | 78.9 | None | 0 | 425 | 276 | 242 | 411 |
| Ex. 14 | 84.8 | 2.5 | 1.7 | 1.8 | 78.8 | None | 0 | 418 | 333 | 349 | 409 |
| Ex. 15 | 85.0 | 2.5 | 1.7 | 1.8 | 79.0 | None | 0 | 368 | 311 | 319 | 412 |
| Ex. 16 | 85.2 | 1.0 | 4.1 | 4.0 | 76.1 | None | 0 | 432 | 338 | 375 | 413 |
| Comp. | 85.0 | 5.0 | — | — | 80.0 | None | 0 | 421 | — | — | 406 |
| Ex. 1 | | | | | | | | | | | |
| Comp. | 84.8 | 5.0 | — | — | 79.8 | optical | 8 | 371 | — | — | 414 |
| Ex. 2 | | | | | | resin | | | | | |
| | | | | | | layer | | | | | |
| Comp. | 85.1 | 5.0 | — | — | 80.1 | resin | 3 | 431 | — | — | 415 |
| Ex. 3 | | | | | | substrate*¹ | | | | | (361) |
| Comp. | 85.0 | 2.4 | 2.4 | 2.5 | 77.7 | optical | 8 | 431 | 320 | 356 | 412 |
| Ex. 4 | | | | | | resin | | | | | |
| | | | | | | layer | | | | | |
| Ex. 20 | 84.8 | 2.6 | 2.3 | 2.6 | 77.3 | None | 0 | 230 | 279 | 295 | 401 |
| Ex. 21 | 85.2 | 2.3 | 2.4 | 2.3 | 78.2 | None | 0 | 610 | 472 | 384 | 285 |
| Ex. 22 | 85.2 | 2.5 | 2.6 | 2.4 | 77.7 | None | 0 | 388 | 410 | 390 | 291 |
| Ex. 23 | 84.9 | 2.5 | 2.5 | 2.3 | 77.6 | None | 0 | 367 | 487 | 463 | 428 |

| | Difference Δ1 in | Difference Δ2 in | | | | | | | |
|---|---|---|---|---|---|---|---|---|---|
| | indentation hardness | indentation hardness | | Ratio of content of 1st | | | | Close adhesion | |
| | between optical resin | between resin substrate | Value | component of resin substrate | | | | Before | After |
| | layer and 1st | layer and 1st | of | Optical | 1st | 2nd | | accelerated | accelerated |
| | intermediate layer | intermediate layer | Δ1-Δ2 | resin | intermediate | intermediate | Resin | weathering | weathering |
| | (MPa) | (MPa) | (MPa) | layer | layer | layer | substrate | test | test |
| Ex. 1 | 107 | 81 | 27 | 0% | 25% | 75% | 100% | A | A |
| Ex. 2 | 75 | 63 | 12 | 10% | 20% | 70% | 100% | A | A |
| Ex. 3 | 84 | 58 | 26 | 0% | 10% | 90% | 100% | A | A |
| Ex. 4 | 146 | 121 | 25 | 0% | 50% | 50% | 100% | A | A |
| Ex. 5 | 278 | 75 | 203 | 0% | 25% | 75% | 100% | A | A |
| Ex. 6 | 53 | 91 | −38 | 15% | 25% | 60% | 100% | A | A |
| Ex. 7 | 63 | 48 | 15 | 0% | 5% | 95% | 100% | A | B |
| Ex. 8 | 143 | 131 | 12 | 5% | 55% | 40% | 100% | A | A |
| Ex. 9 | 92 | 66 | 26 | 0% | 25% | 75% | 100% | A | B |
| Ex. 10 | 98 | 78 | 20 | 0% | 25% | 75% | 100% | A | B |
| Ex. 11 | 97 | 72 | 25 | 0% | 25% | 75% | 100% | A | B |
| Ex. 12 | 98 | 71 | 27 | 0% | 25% | 75% | 100% | A | B |
| Ex. 13 | 149 | 135 | 14 | 5% | 55% | 40% | 100% | A | B |
| Ex. 14 | 85 | 76 | 9 | 10% | 20% | 70% | 100% | A | B |
| Ex. 15 | 57 | 101 | −44 | 15% | 25% | 60% | 100% | A | B |
| Ex. 16 | 94 | 75 | 19 | 0% | 25% | 75% | 100% | A | A |
| Comp. | — | — | — | 0% | — | — | 100% | A | C |
| Ex. 1 | | | | | | | | | |
| Comp. | — | — | — | 0% | — | — | 100% | A | C |
| Ex. 2 | | | | | | | | | |
| Comp. | — | — | — | 0% | — | — | 100% | A | C |
| Ex. 3 | | | | | | | | | |
| Comp. | 111 | 92 | 19 | 0% | 0% | 0% | 100% | A | C |
| Ex. 4 | | | | | | | | | |
| Ex. 20 | 49 | 122 | −73 | 0% | 25% | 75% | 100% | A | B |
| Ex. 21 | 138 | 187 | −49 | 0% | 25% | 75% | 100% | A | B |
| Ex. 22 | 22 | 119 | −97 | 0% | 25% | 75% | 100% | A | B |
| Ex. 23 | 120 | 59 | 61 | 0% | 25% | 75% | 100% | A | B |

*¹Region of 3 μm thickness from optical resin laye side surface of resin substrate
*²Number in the parenthesis is indentation hardenss of the region of 3 μm thickness from optical resin layer side surface of resin substrate

TABLE 2

| | | | | | | | | | | Difference Δ3 in |
|---|---|---|---|---|---|---|---|---|---|---|
| | | | | | | | Indentation | | | indentation hardness |
| | Thickness (μm) | | | | | | hardness (MPa) | | | between optical resin |
| | | Optical | | | UV absorber | | Optical | | | layer and intermediate |
| | | resin | Intermediate | Resin | containing | content | resin | Intermediate | Resin | layer |
| | Whole | layer | layer | substrate | layer | (mass %) | layer | layer | substrate | (MPa) |
| Ex. 17 | 85.3 | 2.6 | 2.6 | 80.1 | None | 0 | 432 | 338 | 413 | 94 |
| Ex. 18 | 85.1 | 2.6 | 2.7 | 79.8 | None | 0 | 437 | 322 | 411 | 115 |
| Ex. 19 | 85.3 | 2.5 | 2.7 | 80.1 | None | 0 | 438 | 349 | 413 | 89 |
| Comp. | 84.9 | 2.4 | 2.5 | 80.0 | optical | 8 | 430 | 320 | 410 | 110 |
| Ex. 5 | | | | | resin | | | | | |
| | | | | | layer | | | | | |

| | Difference Δ4 in | | | | | | |
|---|---|---|---|---|---|---|---|
| | indentation hardness | | Ratio of content of 1st | | | Close adhesion | |
| | between resin substrate | | component of resin substrate | | | Before | After |
| | and 1st intermediate | Value of | Optical | | | accelerated | accelerated |
| | layer | Δ3-Δ4 | resin | Intermediate | Resin | weathering | weathering |
| | Δ4(MPa) | (MPa) | layer | layer | substrate | test | test |
| Ex. 17 | 75 | 19 | 0% | 25% | 100% | A | A |
| Ex. 18 | 89 | 26 | 0% | 40% | 100% | A | A |
| Ex. 19 | 64 | 25 | 0% | 10% | 100% | A | A |
| Comp. | 90 | 20 | 0% | 0% | 100% | A | C |
| Ex. 5 | | | | | | | |

TABLE 3

| | |
|---|---|
| Bending | Hardness characteristics |

| | resistance | SW Resistance | Pencil hardness |
|---|---|---|---|
| Example 1 | B | A | 4 H |
| Example 2 | B | A | 4 H |
| Example 3 | B | A | 4 H |
| Example 4 | C | A | 4 H |
| Example 5 | C | A | 5 H |
| Example 6 | C | B | 2 H |
| Example 7 | A | A | 4 H |
| Example 8 | D | A | 4 H |
| Example 9 | B | A | 4 H |
| Example 10 | B | A | 4 H |
| Example 11 | B | A | 4 H |
| Example 12 | B | A | 4 H |
| Example 13 | D | A | 4 H |
| Example 14 | B | A | 4 H |
| Example 15 | C | B | 2 H |
| Example 16 | B | B | 2 H |
| Example 17 | B | A | 4 H |
| Example 18 | B | A | 4 H |
| Example 19 | B | A | 4 H |
| Example 20 | D | B | 2 B |
| Example 21 | C | A | 5 H |
| Example 22 | C | B | 2 H |
| Example 23 | C | B | 2 H |

In Examples 1 to 16 and 20 to 23, since the first intermediate layer and the second intermediate layer contained a first component configuring the resin substrate, close adhesion was good even after the accelerated weathering test. In addition, in Examples 17 to 19, since the intermediate layer contained a first component configuring the resin substrate, close adhesion was good even after the accelerated weathering test. On the other hand, in Comparative Examples 1 to 3, since the intermediate layer was not disposed between the resin substrate and the optical resin layer, close adhesion was degraded after the accelerated weathering test.

In addition, among Examples 1 to 19, in Examples 1 to 7, 9 to 12, and 14 to 19, since the magnitude relationship of the ratio of the content of the first component in each layer with respect to the content of the first component in the resin substrate was a predetermined relationship, the bending resistance was also good.

In addition, among Examples 1 to 19, in Examples 1 to 5, 9 to 12, and 14, since the ratio of the content of the first component in each layer to the content of the first component in the resin substrate was within a preferable range, the close adhesion after the accelerated weathering test was excellent, and the bending resistance and the hardness characteristic were good.

In addition, from Tables 1 to 3, it was suggested that the higher the indentation hardness of the optical resin layer the higher the hardness characteristic, however, the difference between the indentation hardness of the optical resin layer and the indentation hardness of the other layer was preferably smaller for the bending resistance.

In addition, it was suggested that the bending resistance improved when the indentation hardness of the optical resin layer and the indentation hardness of the resin substrate were both high, and the indentation hardness of the first intermediate layer and the indentation hardness of the second intermediate layer were slightly lower than the indentation hardness of the optical resin layer and the indentation hardness of the resin substrate. Specifically, it is suggested that the bending resistance was favorable when the difference Δ1 between the indentation hardness of the first intermediate layer and the indentation hardness of the optical resin layer and the difference Δ2 between the indentation hardness of the first intermediate layer and the indentation hardness of the resin substrate were both small, preferably less than 120 MPa. Similarly, it was suggested that the bending resistance was favorable when the difference between the indentation hardness of the second intermediate layer and the indentation hardness of the optical resin layer and the difference between the indentation hardness of the second intermediate layer and the indentation hardness of the resin substrate were both small. More specifically, it was suggested that the bending resistance was favorable when the difference between the difference Δ1 between the indentation hardness of the first intermediate layer and the indentation hardness of the optical resin layer, and the difference Δ2 between the indentation hardness of the first intermediate layer and the indentation hardness of the resin substrate was small, preferably 30 MPa or less. Similarly, it was suggested that the bending resistance was favorable when the difference between the difference between the indentation hardness of the second intermediate layer and the indentation hardness of the optical resin layer, and the difference between the indentation hardness of the second intermediate layer and the indentation hardness of the resin substrate was small. This is thought that tensile stress and compressive stress applied during bending of the layered body were well distributed.

In particular, in the above case, when the difference Δ2 between the indentation hardness of the first intermediate layer and the indentation hardness of the resin substrate was smaller than the difference Δ1 between the indentation hardness of the first intermediate layer and the indentation hardness of the optical resin layer, the followability of the first intermediate layer with respect to the resin substrate improved, and thus the bending resistance was favorable. That is, it was suggested that all close adhesiveness, hardness characteristics, and bending resistance were favorable.

Similarly, it was suggested that the bending resistance was favorable when the indentation hardness of the optical resin layer and the indentation hardness of the resin substrate were both high and the indentation hardness of the intermediate layer was slightly lower than the indentation hardness of the optical resin layer and the indentation hardness of the resin substrate. Specifically, it was suggested that the bending resistance was favorable when the difference Δ3 between the indentation hardness of the intermediate layer and the indentation hardness of the optical resin layer and the difference Δ2 between the indentation hardness of the intermediate layer and the indentation hardness of the resin substrate were both small, preferably less than 120 MPa. More specifically, it was suggested that the bending resistance was favorable when the difference between the difference Δ3 between the indentation hardness of the intermediate layer and the indentation hardness of the optical resin layer and the difference Δ4 between the indentation hardness of the intermediate layer and the indentation hardness of the resin substrate was small, preferably 30 MPa or less. This is thought that the tensile stress and the compressive stress applied during the bending of the layered body were well distributed as described above.

In particular, in the above case, when the difference Δ4 between the indentation hardness of the intermediate layer and the indentation hardness of the resin substrate was smaller than the difference Δ3 between the indentation hardness of the intermediate layer and the indentation hardness of the optical resin layer, the followability of the intermediate layer with respect to the resin substrate improved, and thus the bending resistance was favorable. That is, it was suggested that all close adhesiveness, hardness characteristics, and bending resistance were favorable.

On the other hand, when the indentation hardness of the first intermediate layer and the indentation hardness of the second intermediate layer were significantly lower than the indentation hardness of the optical resin layer and the indentation hardness of the resin substrate, and when the indentation hardness of the intermediate layer was significantly lower than the indentation hardness of the optical resin layer and the indentation hardness of the resin substrate, it is considered that the bending resistance decreases because the stress is locally concentrated during the bending of the layered body.

The present disclosure provides the following [1]-[19].
[1] A layered body comprising an optical resin layer, a first intermediate layer, a second intermediate layer, and a resin substrate, in this order, wherein each of the first intermediate layer and the second intermediate layer contains a first component configuring the resin substrate.
[2] The layered body according to [1], wherein a ratio of a content of the first component in each of the layers with respect to a content of the first component in the resin substrate increases in the order of the optical resin layer, the first intermediate layer, the second intermediate layer, and the resin substrate.
[3] The layered body according to [2], wherein
   when the content of the first component in the resin substrate is 100%,
   the ratio of the content of the first component in the second intermediate layer with respect to the content of the first component in the resin substrate is 50% or more and 95% or less,
   the ratio of the content of the first component in the first intermediate layer with respect to the content of the first component in the resin substrate is 10% or more and 50% or less, and
the ratio of the content of the first component in the optical resin layer with respect to the content of the first component in the resin substrate is 0% or more and 10% or less.
[4] The layered body according to any of [1] to [3], wherein each of the first intermediate layer and the second intermediate layer contains a second component configuring the optical resin layer.
[5] The layered body according to any of [1] to [4],
wherein
   an indentation hardness of the optical resin layer is greater than each of an indentation hardness of the first intermediate layer and an indentation hardness of the second intermediate layer, and
an indentation hardness of the resin substrate is greater than each of the indentation hardness of the first intermediate layer and the indentation hardness of the second intermediate layer.
[6] The layered body according to [5], wherein
   the indentation hardness of the optical resin layer is 400 MPa or more,
   each of the indentation hardness of the first intermediate layer and the indentation hardness of the second intermediate layer is 100 MPa or more and 400 MPa or less, and
the indentation hardness of the resin substrate is 240 MPa or more and 600 MPa or less.
[7] The layered body according to any of [1] to [6] wherein each of the thickness of the first intermediate layer and the thickness of the second intermediate layer is 1 μm or more and 5 μm or less.
[8] A layered body comprising an optical resin layer, an intermediate layer, and a resin substrate, in this order, wherein
the intermediate layer contains a first component configuring the resin substrate, and a second component configuring the optical resin layer.
[9] A layered body comprising an optical resin layer, an intermediate layer, and a resin substrate, in this order, wherein
   the intermediate layer contains a first component configuring the resin substrate,
when the layered body is subjected to an accelerated weathering test according to JIS K 5600-7-8: 1999 described below, and then an adhesive test is performed by a cross-cut tape method according to JIS K 5400-8.5.2, the number of remaining squares among the 100 squares is 90 or more.

### (Condition of Accelerated Weathering Test)

Operation: Method A, Exposure including steam condensation
UV lamp: Type 2 UVA (340)
Irradiation: Radiated illuminance of 0.63 W/m², temperature of 23±5° C., black panel temperature of 60±3° C., and irradiation time of 4 hours
Steam Condensation: Black panel temperature of 50±3° C., and water condensation time of 4 hours
One cycle: The irradiation and the water vapor condensation are sequentially performed to be one cycle.
Cycle number: 12 cycles
[10] The layered body according to [9], wherein the intermediate layer contains a second component configuring the optical resin layer.
[11] The layered body according to any of [8] to [10] wherein a ratio of a content of the first component in each of the layers with respect to a content of the first component in the resin substrate increases in the order of the optical resin layer, the intermediate layer, and the resin substrate.
[12] The layered body according to [11], wherein
   when the content of the first component in the resin substrate is 100%,
   a ratio of the content of the first component in the intermediate layer with respect to the content of the first component in the resin substrate is 10% or more and 95% or less, and
   a ratio of the content of the first component in the optical resin layer with respect to the content of the first component in the resin substrate is 0% or more and 10% or less.
[13] The layered body according to any of [8] to [12], wherein
   an indentation hardness of the optical resin layer is greater than an indentation hardness of the intermediate layer, and
an indentation hardness of the resin substrate is greater than the indentation hardness of the intermediate layer.
[14] The layered body according to [13], wherein
   the indentation hardness of the optical resin layer is 400 MPa or more,
   the indentation hardness of the intermediate layer is 100 MPa or more and 400 MPa or less, and
the indentation hardness of the resin substrate is 240 MPa or more and 600 MPa or less.
[15] The layered body according to any of [8] to [14], wherein a thickness of the intermediate layer is 1 μm or more and 5 μm or less.
[16] The layered body according to any of [1] to [15], wherein the resin substrate contains a resin component including at least one selected from the group consisting of an imide skeleton, an amide skeleton, and an ester skeleton.
[17] The layered body according to any of [1] to [16], wherein a thickness of the optical resin layer is 1 μm or more and 20 μm or less.
[18] A touch panel member comprising the layered body according to any of [1] to [17] on its surface.
[19] A display device comprising:
   a display panel; and
the layered body according to [1] to [17] disposed on an observer side of the display panel.

### REFERENCE SIGNS LIST

1, 1A, 1B . . . layered body
2 . . . resin Substrate
3 . . . first intermediate layer
4 . . . second intermediate layer
5 . . . resin substrate
6 . . . intermediate layer
10 . . . display device
11 . . . display panel

1. A layered body comprising:
an optical resin layer;
a first intermediate layer;
a second intermediate layer; and
a resin substrate, in this order,
wherein each of the first intermediate layer and the second intermediate layer comprises a first component forming the resin substrate.

2. The layered body according to claim 1,
wherein a ratio of a content of the first component in each of the layers relative to a content of the first component in the resin substrate increases in an order of the optical resin layer, the first intermediate layer, the second intermediate layer, and the resin substrate.

3. The layered body according to claim 2,
wherein as the content of the first component in the resin substrate is 100%,
the ratio of the content of the first component in the second intermediate layer relative to the content of the first component in the resin substrate is in a range from 50% to 95%,
the ratio of the content of the first component in the first intermediate layer relative to the content of the first component in the resin substrate is in a range from 10% to 50%, and
the ratio of the content of the first component in the optical resin layer relative to the content of the first component in the resin substrate is in a range from 0% to 10%.

4. The layered body according to claim 1,
wherein each of the first intermediate layer and the second intermediate layer comprises a second component forming the optical resin layer.

5. The layered body according to claim 1,
wherein an indentation hardness of the optical resin layer is greater than each of an indentation hardness of the first intermediate layer and an indentation hardness of the second intermediate layer, and
an indentation hardness of the resin substrate is greater than each of the indentation hardness of the first intermediate layer and the indentation hardness of the second intermediate layer.

6. The layered body according to claim 5,
wherein the indentation hardness of the optical resin layer is 400 MPa or more,
each of the indentation hardness of the first intermediate layer and the indentation hardness of the second intermediate layer is in a range from 100 MPa to 400 MPa, and
the indentation hardness of the resin substrate is in a range from 240 MPa to 600 MPa.

7. The layered body according to claim 1,
wherein each of a thickness of the first intermediate layer and a thickness of the second intermediate layer is in a range from 1 μm to 5 μm.

8. A layered body comprising:
an optical resin layer;
an intermediate layer; and
a resin substrate, in this order,
wherein the intermediate layer comprises a first component forming the resin substrate, and a second component forming the optical resin layer.

9. A layered body comprising:
an optical resin layer;
an intermediate layer; and
a resin substrate, in this order,
wherein the intermediate layer comprises a first component forming the resin substrate,
when the layered body is subjected to an accelerated weathering test according to JIS K 5600-7-8: 1999 described below, and then an adhesive test is performed by a cross-cut tape method according to JIS K 5400-8.5.2, a number of remaining squares among 100 squares is 90 or more, wherein conditions of the accelerated weathering test are:
Operation: Method A, Exposure including steam condensation
UV lamp: Type 2 UVA (340)
Irradiation: Radiated illuminance of 0.63 W/m2, temperature of 23±5° C., black panel temperature of 60±3° C., and irradiation time of 4 hours
Steam Condensation: Black panel temperature of 50±3° C., and water condensation time of 4 hours
One cycle: the irradiation and the water vapor condensation are sequentially performed to be one cycle, and
Cycle number: 12 cycles.

10. The layered body according to claim 9, wherein the intermediate layer comprises a second component forming the optical resin layer.

11. The layered body according to claim 8,
wherein a ratio of a content of the first component in each of the layers relative to a content of the first component in the resin substrate increases in an order of the optical resin layer, the intermediate layer, and the resin substrate.

12. The layered body according to claim 11,
Wherein as the content of the first component in the resin substrate is 100%,
a ratio of a content of the first component in the intermediate layer relative to a content of the first component in the resin substrate is in a range from 10% to 95%, and
a ratio of a content of the first component in the optical resin layer relative to a content of the first component in the resin substrate is in a range from 0% to 10%.

13. The layered body according to claim 8,
wherein an indentation hardness of the optical resin layer is greater than an indentation hardness of the intermediate layer, and
an indentation hardness of the resin substrate is greater than the indentation hardness of the intermediate layer.

14. The layered body according to claim 13,
wherein the indentation hardness of the optical resin layer is 400 MPa or more,
the indentation hardness of the intermediate layer is in a range from 100 MPa to 400 MPa, and
the indentation hardness of the resin substrate is in a range from 240 MPa to 600 MPa.

15. The layered body according to claim 8,
wherein a thickness of the intermediate layer is in a range from 1 μm to 5 μm.

16. The layered body according to claim 1,
wherein the resin substrate comprises a resin component including at least one structure selected from the group consisting of an imide skeleton, an amide skeleton, and an ester skeleton.

17. The layered body according to claim 1,
wherein a thickness of the optical resin layer is in a range from 1 μm to 20 μm.

18. A touch panel member comprising the layered body according to claim 1, on a surface thereof.

19. A display device comprising:
a display panel; and
the layered body according to claim 1, disposed on an observer side of the display panel.
